(19) United States
(12) Patent Application Publication
(10) Pub. No.: US 2007/0286353 A1
(43) Pub. Date: Dec. 13, 2007

(54) Congestion control method, subscriber terminal used in the congestion control method, disaster system, and core network

(75) Inventor: Yayoi Itoh, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/505,389

(22) Filed: Aug. 17, 2006

(30) Foreign Application Priority Data
May 29, 2006 (JP) 2006-148339

(51) Int. Cl. H04M 11/04

(52) U.S. Cl. 379/37

(57) ABSTRACT

A congestion control method includes the steps of: calling from a first subscriber terminal to a second subscriber terminal, the second subscriber terminal positioned within a communication restriction area, communicating to the first subscriber terminal that connection to the second subscriber terminal cannot be made; and making the first subscriber terminal select one of a disaster system or an e-mail function.

### BACKGROUND OF THE INVENTION

1. Field of the Invention

The present invention generally relates to congestion control methods, subscriber terminals used in the congestion control methods, disaster systems, and core networks, and more specifically, to a congestion control method whereby congestion of a communication system at the time when a disaster occurs is eased, a subscriber terminal used in the congestion control method, a disaster system and a core network

2. Description of the Related Art

It is expected that the load on a mobile communication system will be increased at the time of an occurrence of a disaster due to inquiries about the safety of people in the disaster occurrence area.

In order to reduce the load on the mobile communication system and ease congestion of the mobile communication system at the time of the occurrence of the disaster, mainly the following technologies are used. The following technologies have no relationship with each other and are used individually.

In a first technology, when a large number of calling are generated so that the congestion state exists, receiving a call or making a call from a switching network is restricted, and thereby normality of the system can be secured. In addition, at the time when the congestion is expected but before the congestion state actually occurs, receiving a call or making a call from the switching network may be restricted.

In this case, a subscriber cannot perform operations using a portable terminal. Hence, the portable terminal cannot be used for confirming safety and rescue at the time of the occurrence of the disaster.

In a second technology, a message dial service for disaster is used wherein a message with respect to status at the time of the occurrence of the disaster can be left by dialing a specific phone number. The message dial service for disaster transfers information about the safety or the like with voice by using a phone number in a disaster-stricken area as a mail box. In other words, a person in the disaster area connects to the message dial service and records the message by using the phone number of the person as a key. The subscriber who wishes to contact to the person in the disaster area replays the message by using the phone number of the person as the key.

In a third technology, a Web service for disaster that is similar to the message dial service is used. While the voice is recorded in the message dial service, information such as a character or text is recorded in the Web service. In other words, the person in the disaster area connects to the Web for disaster and records the character or text by using the phone number of the person as a key. The subscriber who wishes to contact to the person in the disaster area replays the character or text by using the phone number of the person as the key.

Japanese Laid-Open Patent Application Publication No. 10-75309 discloses the following technology. That is, when a subscriber in a disaster-stricken area dials a special number for the storage voice service, the call is connected to the voice service device. The voice service device stores the message from the subscriber in a voice storage transmission section. Thereafter, when another subscriber from a subscriber system exchange of another area dials a subscriber of a subscriber system exchange in the disaster-stricken area to confirm safety or the like and when the message has been recorded, the registered message is sent from the voice storage transmission section.

Japanese Laid-Open Patent Application Publication No. 9-233194 discloses a technology that if a subscriber makes a call to an area where receiving a call is restricted, the call is bypass-connected to a voice storage device.

However, in the first technology, making a call is restricted at a system side at the time of the occurrence of the disaster so that it is attempted to prevent the system from reaching the congestion state. When such a restriction is made, only a display of the restriction or notification by an alarm sound such as a busy tone is made on the portable terminal of the subscriber.

In this case, the subscriber may attempt to make a call any number of times until calling is received by an opponent. This may cause the increase of the congestion state so that a situation where calling is not connected due to the restriction may be maintained for a long period of time.

The second technology whereby the safety is confirmed with the message dial service for disaster and the third technology whereby the safety is confirmed with a menu for disaster displayed on the portable terminal at the time of the occurrence of the disaster are not useful. This is because the subscriber may not memorize these accessing methods or the phone number of the person in the disaster area. Hence, the subscriber may keep trying to make a call.

### SUMMARY OF THE INVENTION

Accordingly, the present invention may provide a novel and useful congestion control method, a subscriber terminal used in the congestion control method, disaster system and core network solving one or more of the problems discussed above.

Another and more specific object of the present invention may be to provide a congestion control method whereby contact with a subscriber terminal in a communication restriction area can be made, so that the load on a communication system can be reduced and congestion of the communication system can be eased; a subscriber terminal used in the congestion control method; a disaster system and a core network.

The above object of the present invention is achieved by a congestion control method, including the steps of: calling from a first subscriber terminal to a second subscriber terminal, the second subscriber terminal positioned within a communication restriction area, communicating to the first subscriber terminal that connection to the second subscriber terminal cannot be made; and making the first subscriber terminal select one of a disaster system or an e-mail function.

When the disaster system is selected by the first subscriber terminal, the disaster system may store a message from the first subscriber terminal to the second subscriber terminal, and when communication restriction of the second subscriber terminal is lifted, the disaster system may call the second subscriber terminal so as to communicate the message. When the communication restriction of the second subscriber terminal is lifted, the disaster system repeatedly may call the second subscriber terminal until the second subscriber terminal receives the calling. The second subscriber terminal may notify the disaster system that the message is received. When the e-mail function is selected by the first subscriber terminal, an emergency e-mail generated by the first subscriber terminal may be sent to the second subscriber terminal and stored by the disaster system. The disaster system may be one of a disaster message service and a disaster Web site.

The above object of the present invention is achieved by a congestion control method, including: when calling is made from a first subscriber terminal to a second subscriber terminal positioned within a communication restriction area, indicating to the first subscriber terminal that connection to the second subscriber terminal cannot be made; connecting to a disaster system by the first subscriber terminal so that a message is sent to the second subscriber terminal; storing the message from the first subscriber terminal to the second subscriber terminal by the disaster system; and calling the second subscriber terminal by the disaster system when communication restriction of the second subscriber terminal is lifted, so that the message is sent.

The above object of the present invention is achieved by a congestion control method, including: when calling is made from a first subscriber terminal to a second subscriber terminal positioned within a communication restriction area, indicating to the first subscriber terminal that connection to the second subscriber terminal cannot be made; generating an emergency e-mail to the second subscriber terminal by an e-mail function of the first subscriber terminal; and sending the emergency e-mail to the second subscriber terminal and storing the emergency e-mail by a disaster system.

The above object of the present invention is achieved by a congestion control method, including: when calling is made from a first subscriber terminal to a second subscriber terminal positioned within a communication restriction area, indicating a restriction state in the communication restriction area to the first subscriber terminal; and determining switching to connection to a disaster system or an e-mail function, depending on the restriction state, by the first subscriber terminal.

The above object of the present invention is achieved by a congestion control method, including: when calling is made from a first subscriber terminal to a second subscriber terminal positioned within a communication restriction area, indicating a restriction state in the communication restriction area to the first subscriber terminal; and indicating selectable switching to connection to a disaster system or an e-mail function, depending on the restriction state, to the first subscriber terminal, and making the first subscriber terminal select either switching.

The above object of the present invention is achieved by a subscriber terminal, including: an indicating part configured to select switching to either connection to a disaster system or an e-mail function, in a case where a core network indicates that connection to another subscriber terminal positioned within a communication restriction area cannot be made while calling to the other subscriber terminal is being attempted. The connection to the disaster system may be either connection to a disaster message service or access to a disaster Web site.

The above object of the present invention is achieved by a disaster system, including: a storing part configured to store a message from a first subscriber terminal to a second subscriber terminal; a monitoring part configured to monitor a core network so as to monitor a state of receiving restriction of the second subscriber terminal; and a message notifying part configured to call the second subscriber terminal in a case where communication restriction of the second subscriber terminal is lifted and send the message stored in the storing part and to the second subscriber terminal. The message notifying part may call the second subscriber terminal until the second subscriber terminal receives the message in a case where the communication restriction of the second subscriber terminal is lifted.

The above object of the present invention is achieved by a core network, including an e-mail refusing mode lifting part configured to lift an e-mail refusing mode, in a case where an emergency e-mail is sent from a first subscriber terminal to a second subscriber terminal positioned within a communication restriction area and the second subscriber terminal is in the e-mail refusing mode; and an emergency e-mail notifying part configured to send the emergency e-mail to a disaster system.

According to an embodiment of the present invention, it is possible to contact the subscriber terminal in the communication restriction area so that the load on the communication system can be reduced and the congestion of the communication system can be eased.

Other objects, features, and advantages of the present invention will be come more apparent from the following detailed description when read in conjunction with the accompanying drawings.

### BRIEF DESCRIPTION OF THE DRAWINGS

FIG. 1 is a view showing a structure of a mobile communication network where the present invention is applied;

FIG. 2 is a functional structural view of a subscriber terminal;

FIG. 3 is a functional structural view of a core network;

FIG. 4 is a functional structural view of a disaster system;

FIG. 5 is a diagram of sequence between devices of an example where an alternative method instead of the phone call can be selected;

FIG. 6A is a first diagram of sequence between devices of an example where “(1-1) Connect to disaster message service” is selected by the subscriber;

FIG. 6B is a second diagram of the sequence between the devices of the example where “(1-1) Connect to disaster message service” is selected by the subscriber;

FIG. 6C is a third diagram of the sequence between the devices of the example where “(1-1) Connect to disaster message service” is selected by the subscriber;

FIG. 7A is a first diagram of sequence between devices of an example where “(1-2) Access to disaster Web site” is selected by the subscriber;

FIG. 7B is a second diagram of the sequence between the devices of the example where “(1-2) Access to disaster Web site” is selected by the subscriber;

FIG. 7C is a third diagram of the sequence between the devices of the example where “(1-2) Access to disaster Web site” is selected by the subscriber;

FIG. 8A is a first diagram of sequence between devices of a modified example of the example shown in FIG. 7;

FIG. 8B is a second diagram of the sequence between the devices of the modified example of the example shown in FIG. 7;

FIG. 8C is a third diagram of the sequence between the devices of the modified example of the example shown in FIG. 7;

FIG. 9A is a first diagram of sequence between devices of an example where “(1-3) Switch to e-mail function” is selected by the subscriber;

FIG. 9B is a second diagram of the sequence between the devices of the example where “(1-3) Switch to e-mail function” is selected by the subscriber;

FIG. 10A is a first diagram of sequence between devices of an example for automatically connecting to disaster message service;

FIG. 10B is a second diagram of the sequence between the devices of the example for automatically connecting to the disaster message service;

FIG. 10C is a third diagram of the sequence between the devices of the example for automatically connecting to the disaster message service;

FIG. 11A is a first diagram of sequence between devices of an example for automatically accessing to a disaster Web site;

FIG. 11B is a second diagram of the sequence between the devices of the example for automatically accessing to the disaster Web site;

FIG. 11C is a third diagram of the sequence between the devices of the example for automatically accessing to the disaster Web site;

FIG. 12A is a first diagram of sequence between devices of an example for automatically switching to an e-mail function;

FIG. 12B is a second diagram of the sequence between the devices of the example for automatically switching to the e-mail function;

FIG. 13 is a diagram of sequence between devices of an example where an alternative method instead of calling is determined depending on the restriction state (restriction ratio); and

FIG. 14 is a diagram of sequence between devices of an example where there is an alternative method which the subscriber can select depending on the restriction state (restriction ratio).

### DETAILED DESCRIPTION OF THE PREFERRED EMBODIMENTS

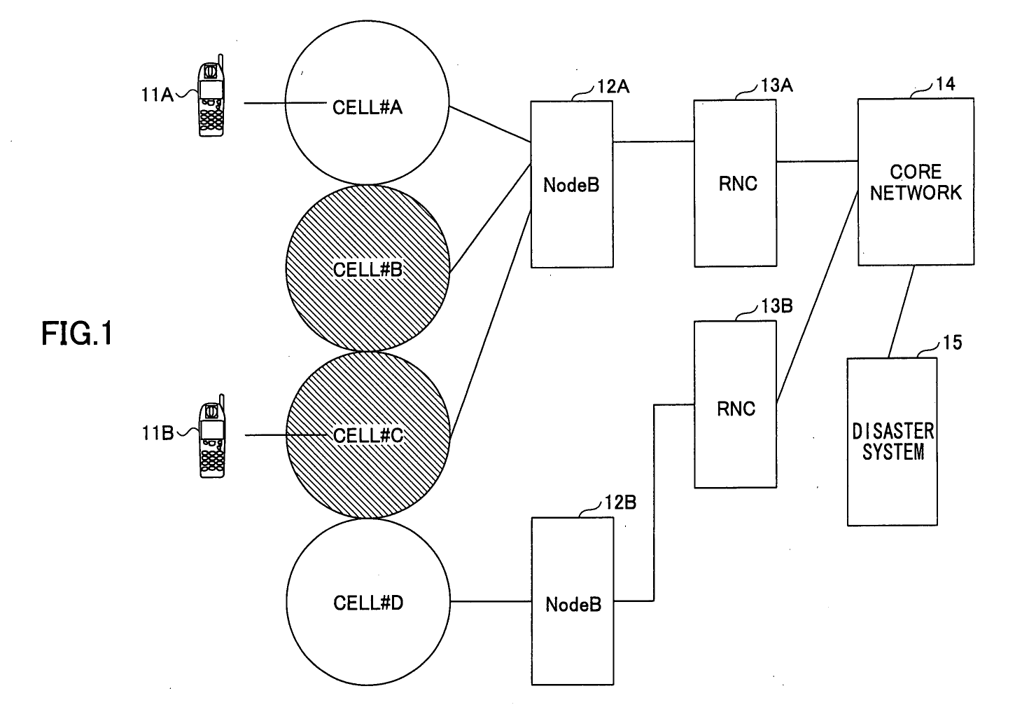

A description is given below, with reference to the FIG. 1 through FIG. 14 of embodiments of the present invention.

### First Embodiment of the Present Invention

FIG. 1 is a view showing a structure of a mobile communication network where the present invention is applied.

The mobile communication network is formed in a pyramid structure by subscriber terminals (UE) 11A and 11B, radio base stations (Node B) 12A and 12B, radio network control devices (RNC) 13A and 13B, a core network 14, and others. A disaster system 15 is connected to the core network 14.

The subscriber terminals 11A and 11B are, for example, mobile terminals. The subscriber terminals 11A and 11B are connected to the radio network control devices 13A and 13B via the radio base stations 12A and 12B. Even during communication, the subscriber terminals 11A and 11B can be moved with users.

The radio base stations 12A and 12B control plural cells (small radio zones) so that multiplex communications with plural subscriber terminals 11A and 11B can be done via plural cells. The radio base stations 12A and 12B have abilities for relaying calling control signals from the subscriber terminals 11A and 11B to the radio network control devices 13A and 13B and abilities for relaying radio circuit control signals from the radio network control devices 13A and 13B to the subscriber terminals 11A and 11B.

The radio network control devices 13A and 13B perform radio circuit controls, calling connection controls, and moving (hand over) controls between the radio network control devices 13A and 13B or the radio base stations 12A and 12B. The radio network control devices 13A and 13B also perform communication speed controls of the subscriber terminals 11A and 11B.

The radio network control devices 13A and 13B report the signals from the subscriber terminals 11A and 11B to the core network 14 via the radio base stations 12A and 12B at the time of making a call so as to perform the radio circuit control with the corresponding radio base station 12. The radio network control devices 13A and 13B also report the signals from the core network 14 to the radio base stations 12A and 12B existing at neighbors of the subscriber terminals 11A and 11B at the time of receiving a call, and receive responses via the radio base stations 12A and 12B where the subscriber terminals 11 are present so that the connection control is performed.

The core network 14 is a connection node of a circuit switching network and a radio circuit network. In a case where a calling connection request from the radio circuit network is to the outside of the radio circuit network, the core network 14 performs the connection control with the switching network. In a case where a receiving request is made from the outside of the radio circuit network and the positions of the subscriber terminals 11A, 11B, which are receivers, are within the radio circuit network, the core network 14 reports the receiving signal to the radio network control devices 13A, 13b in corresponding areas.

The disaster system 15 is connected to the core network 14 via the network so as to work in closer cooperation or control the message service system or Web system for disaster.

In FIG. 1, restrictions are applied to the cells #B and #C indicated by hatching among the cells #A through #C belonging to the radio base station 12A. The subscriber 11B is a receiving subscriber present in the cell #C that is a subject of the restriction.

### [Structure of Subscriber Terminal (UE)]

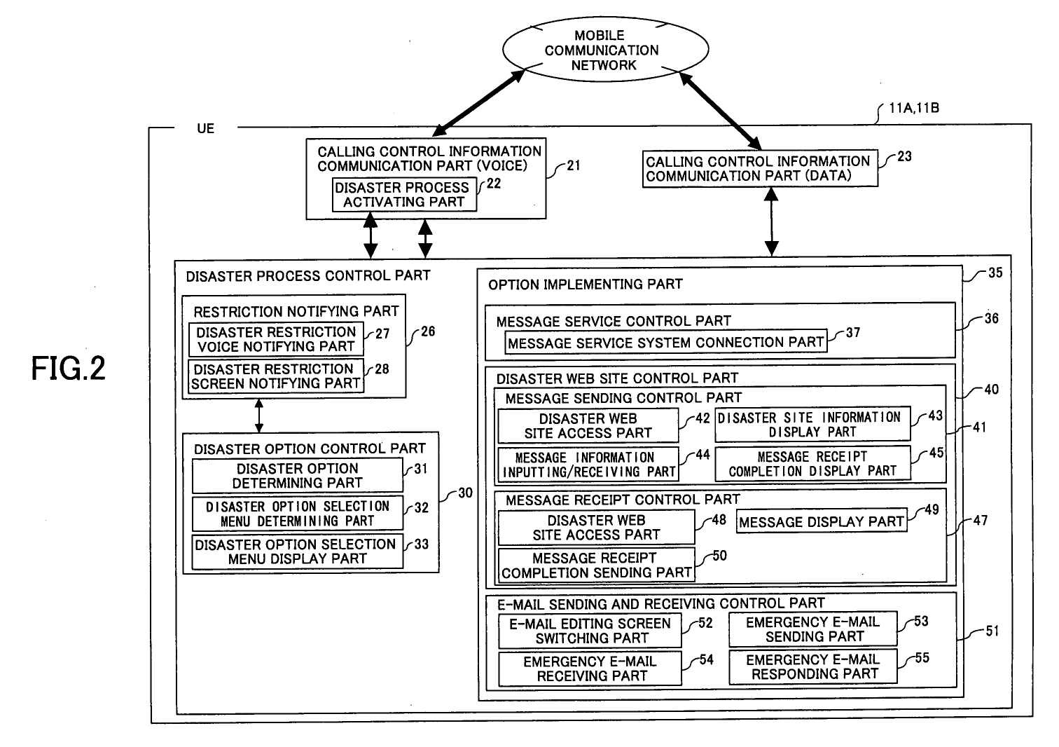

FIG. 2 is a functional structural view of the subscriber terminal.

Referring to FIG. 2, a calling control information communication part (voice) 21 performs a calling control process of voice calling. A disaster process activating part 22 in the calling control information communication part (voice) 21 activates a process for disaster if calling made by the subscriber is refused by disaster restriction. A calling control information communication part (data) 23 performs calling control of data calling.

A disaster process control part 25 implements control of a disaster process. A restriction notifying part 26 of the disaster process control part 25 notifies that calling cannot be made due to the disaster restriction. A disaster restriction voice notifying part 27 in the restriction notifying part 26 notifies by voice that calling cannot be made due to the disaster restriction. A disaster restriction screen notifying part 28 notifies by a display screen that calling cannot be made due to the disaster restriction.

A disaster option control part 30 controls an option process implemented as an alternative to the restricted calling. A disaster option determining part 31 in the disaster option control part 30 determines which option is used by a restriction mode when the option process implemented as the alternative to the restricted calling is automatically implemented. A disaster option selection menu determining part 32 determines a selection menu by a restriction mode when the option process implemented as the alternative of the restricted calling is a subscriber selection. A disaster option selection menu display part 33 displays a determined selection menu.

An option implementing part 35 implements an option selected by the subscriber or an option automatically determined, as the alternative to the restricted calling. A message service control part 36 in the option implementing part 35 implements a control process in the case of the message service. A message service system connection part 37 adds information of a message service special number, a sending subscriber number, or a receiver subscriber number so that a connection with the message service system is made.

A disaster Web site control part 40 implements a control process in the case of a disaster Web site. A message sending control part 41 in the disaster Web site control part 40 implements a control process when the message is sent to the Web system. A disaster Web site access part 42 adds information of the sending subscriber number or the receiving subscriber number so as to connect to the disaster Web site system.

A disaster site information display part 43 displays site information received from the disaster Web site system. A message information inputting/receiving part 44 sends the message input by the subscriber to the disaster Web site system. A message receipt completion display part 45 displays a message receipt completion message received from the disaster Web site system.

A message receipt control part 47 implements a control process in a case where the message is received from the Web system. A disaster Web site access part 48 in the message receipt control part 47 implements switching to the Web site when receiving the message. A message display part 49 displays the received message. A message receipt completion sending part 50 sends information about the receipt of the message.

An e-mail sending and receiving control part 51 implements a control process in a case of e-mail function switching. An e-mail editing screen switching part 52 in the e-mail sending and receiving control part 51 implements switching to an e-mail editing screen. An emergency e-mail sending part 53 adds information that this e-mail is an emergency e-mail so as to send the e-mail. An emergency e-mail receiving part 54 adds indication of emergency at the time when the emergency e-mail is received so as to display it on the screen. An emergency e-mail responding part 55 receives the emergency e-mail. When opening of the e-mail is recognized, the emergency e-mail responding part 55 automatically edits an e-mail indicating that e-mail confirmation is completed and automatically sends it to an e-mail sender.

### [Structure of Core Network]

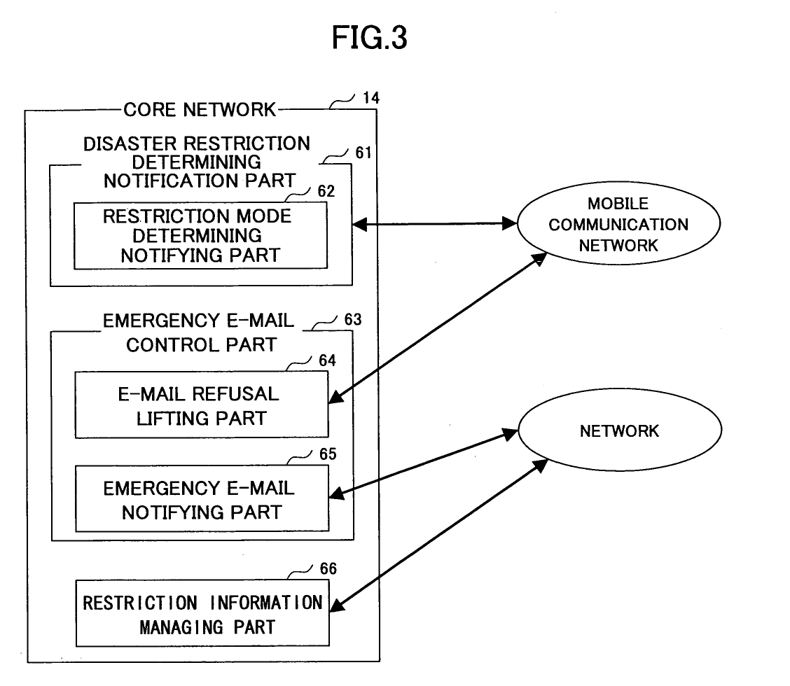

FIG. 3 is a functional structural view of a core network. In FIG. 3, a disaster restriction determining notification part 61 determines if the Subscriber presents a disaster stricken restriction area and notifies them that calling is restricted by the disaster. A restriction mode determining notifying part 62 in the disaster restriction determining notification part 61 determines and sends a restriction mode notification by a restriction rate (voice calling or data calling) in a restriction area.

An emergency e-mail control part 63 implements a control process in a case where the disaster emergency e-mail is received. An e-mail refusal lifting part 64 in the emergency e-mail control part 63 sends an e-mail notification about the emergency e-mail to receiver even if a mode is a refusal mode. An emergency e-mail notifying part 65 sends the e-mail information to not only the subscriber but also the disaster system 15 in the case of the emergency e-mail. A restriction information managing part 66 manages the restriction rate (voice calling or data calling) in the disaster-stricken restriction area and notifies corresponding to a request from the disaster system.

### <Structure of Disaster System>

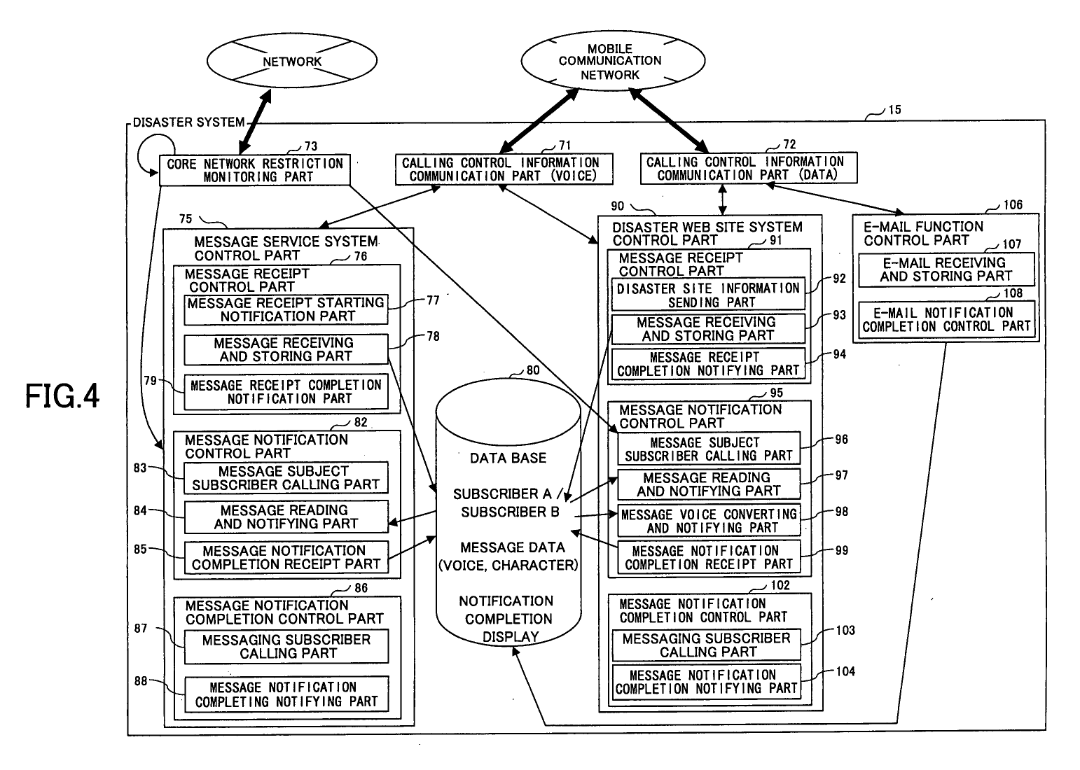

FIG. 4 is a functional structural view of a disaster system. Here, while the disaster system is described as a single system in FIG. 4, each of the blocks inside the system may represent a different server.

In FIG. 4, a calling control information communication part (voice) 71 implements communication with a portable terminal via the core network 14 in a normal voice calling step. A calling control information communication part (data) 72 implements communication with a portable terminal via the core network 14 in a normal data calling step. A core network restriction monitoring part 73 periodically monitors the restriction state of the core network 14 via the network.

A message service system control part 75 controls a message service system. A message receipt control part 76 in the message service system control part 75 controls message receipt from the sender subscriber. A message receipt starting notification part 77 in the message receipt control part 76 notifies the subscriber of the start of the message receipt.

A message receiving and storing part 78 receives the message from the subscriber and stores the message in a data base 80 by using a subscriber number (messaging subscriber, message subject subscriber) as a key. A message receipt completion notification part 79 notifies a sender subscriber (messaging subscriber) that the message receipt is completed.

A message notification control part 82 implements a control process of message notification to the message subject subscriber. A message subject subscriber calling part 83 in the message notification control part 82 calls the message subject subscriber. A message reading and notifying part 84 reads out the message whose address is the message subject subscriber and sends notification. A message notification completion receipt part 85 receives message notification completion information.

A message notification completion control part 86 controls message completion notification implemented to the messaging subscriber. A messaging subscriber calling part 87 in the message notification completion control part 86 implements calling the messaging subscriber. A message notification completing notifying part 88 notifies completion of the message notification.

A disaster Web site system control part 90 implements a control process of a disaster Web site system. A message receipt control part 91 in the disaster Web site system control part 90 implements a control process of the message receipt from the sender subscriber. A disaster site information sending part 92 in the message receipt control part 91 send disaster information of the disaster Web site. A message receiving and storing part 93 receives message information from the subscriber and stores the message information into the database 80 by using the subscriber number (messaging subscriber, message subject subscriber) as a key. A message receipt completion notifying part 94 notifies the sending subscriber (messaging subscriber) that the message receipt is completed.

A message notification control part 95 controls the message notification to the message subject subscriber. A message subject subscriber calling part 96 in the message notification control part 95 calls the message subject subscriber. A message reading and notifying part 97 reads out the message information (data) whose address is the message subject subscriber and notifies. A message voice converting and notifying part 98 converts the message information (data) to voice information and notifies. A message notification completion receipt part 99 receives message notification completion information.

A message notification completion control part 102 controls message completion notification being sent to the messaging subscriber. A messaging subscriber calling part 103 in the message notification completion control part 102 calls the messaging subscriber. A message notification completion notifying part 104 notifies that the message notification is completed.

An e-mail function control part 106 controls the disaster e-mails. An e-mail receiving and storing part 107 in the e-mail function control part 106 receives emergency e-mail response information and emergency e-mail information and from the subscriber, and stores it into the database 80 by using the subscriber number (messaging subscriber, message subject subscriber) as the key. An e-mail notification completion control part 108 controls the e-mail completion notification being sent to an e-mail sending subscriber.

Subscriber terminal information of the messaging subscriber, subscriber terminal information of the message subject subscriber, message data (voice, characters), e-mail, notification completion display, or the like is stored in the database 80.

### <<Operation in a Case Where a Receiving Side is Within a Cell that is a Subject of Restriction>>

In a case where calling from the subscriber terminal A to the subscriber terminal B is opened because the subscriber terminal 11B is within a cell #C that is a subject of restriction, there are four options for the subscriber performing the next action.

### (1) Alternative method instead of a telephone call can be selected.

### (2) Automatically (forcibly) performing the alternative method instead of the telephone call.

### (3) Automatically (forcibly) performing the alternative method instead of the telephone call corresponding to a status of restriction (restriction rate).

### (4) Determining an alternative method that can be selected by the subscriber corresponding to the status of restriction.

### <1. Alternative Method Instead of a Telephone Call can be Selected.>

In a case where the subscriber terminal 11A calls the subscriber terminal 11B in a restricted state due to the disaster, what restriction to the subscriber terminal 11B exists due to the disaster, and therefore that a phone call by voice cannot be made is announced to the subscriber terminal 11A or displayed on a portable screen of the subscriber terminal 11A, and the following selection screens are displayed.

### (1-1) Connect to disaster message service

### (1-2) Access to disaster Web site

### (1-3) Switch to e-mail function (in a short e-mail format or an e-mail format if e-mail address of the subscriber terminal 11B is registered)

If the subscriber terminal 11A selects one of the above-mentioned items, the subscriber terminal 11A connects to the disaster message service system of the disaster system, connects to the disaster Web site, or switches to the main function.

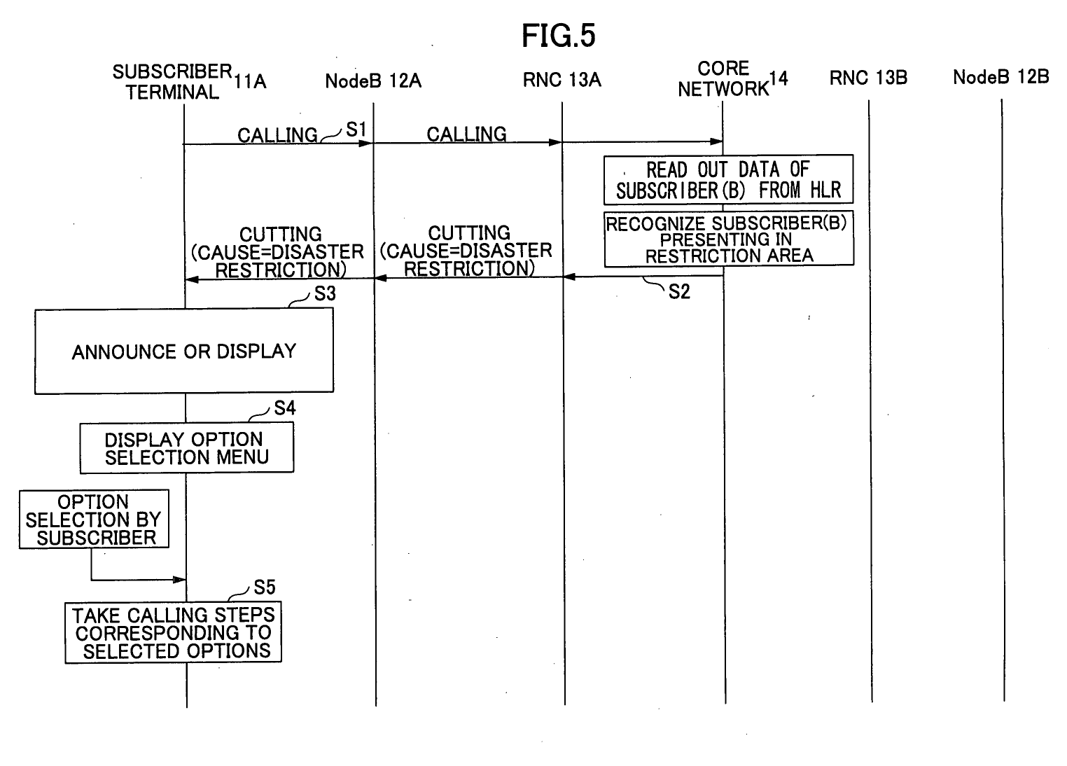

FIG. 5 is a diagram of sequence between devices of an example where the alternative method instead of the phone call can be selected.

If the subscriber terminal 11A calls the subscriber terminal 11B, a calling signal is sent by the subscriber terminal 11A, the radio base station 12A, the radio network control device 13A, and the core network 14, in this order (Step 1).

In the core network 14, based on the input from a maintenance console or notification from a subordinate device, information of the restricted cell (RNC number+Node B number, cell number) is recognized in advance. In the core network 14 receiving the calling signal, the cell in which subscriber terminal 11B presently is found by using the receiving subscriber number and that connection cannot be made due to the restriction are communicated to the subscriber terminal 11A (Step 2).

The subscriber terminal 11A receiving the notification does not output a normal busy tone. The subscriber terminal 11A activates the disaster steps and announces to the subscriber that the phone call by voice cannot be done. Alternatively, that the phone call by the voice cannot be done is displayed on the screen of the subscriber terminal 11A (Step 3).

An option selection menu (Connect to disaster message service/Access to disaster Web site/Switch to e-mail function) is displayed on a subscriber terminal screen so as to encourage the subscriber to select the options (Step 4).

With the option selection by the subscriber as a trigger, steps corresponding to the options are taken in the subscriber terminal 11A (Step 5).

### <(1-1) Connect to Disaster Message Service>

The subscriber terminal 11A automatically connects to the message service system of the disaster system 15.

In the message service system control part 76, an announcement that encourages the subscriber terminal 11A to start messaging is made or encouragement of starting messaging is displayed on the portable screen. If a message is left by the subscriber terminal 11A, the message service system control part 76 stores the message from the subscriber terminal 11A in the database 80 as a message to the subscriber terminal 11B.

The disaster system 15 lifts the calling restriction and periodically monitors the congestion state. If the congestion is eased, the message service system calls the subscriber terminal 11B so as to report the existence of the message and contents of the message. If the subscriber terminal 11B does not respond to the calling, the calling is periodically repeated until the subscriber terminal 11B responds to the calling.

After the subscriber terminal 11B hears the message, if a specific key such as “#” is pushed, it is reported that the subscriber terminal 11B surely hears the message, from the message service system to the subscriber terminal 11A.

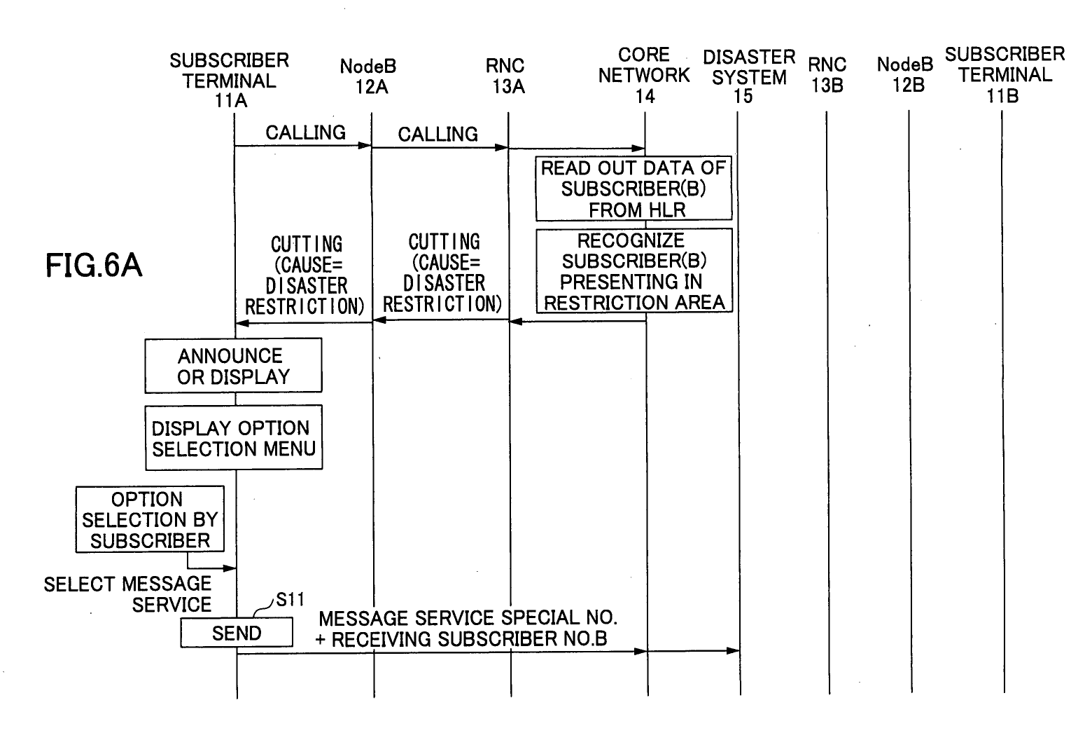

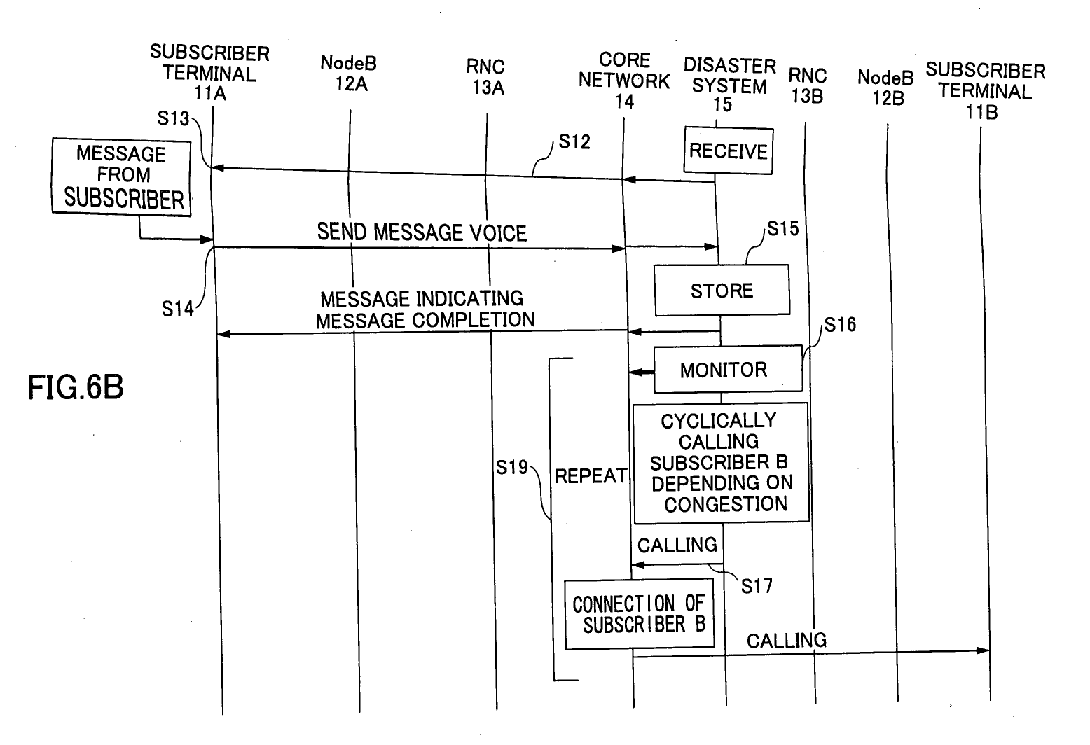

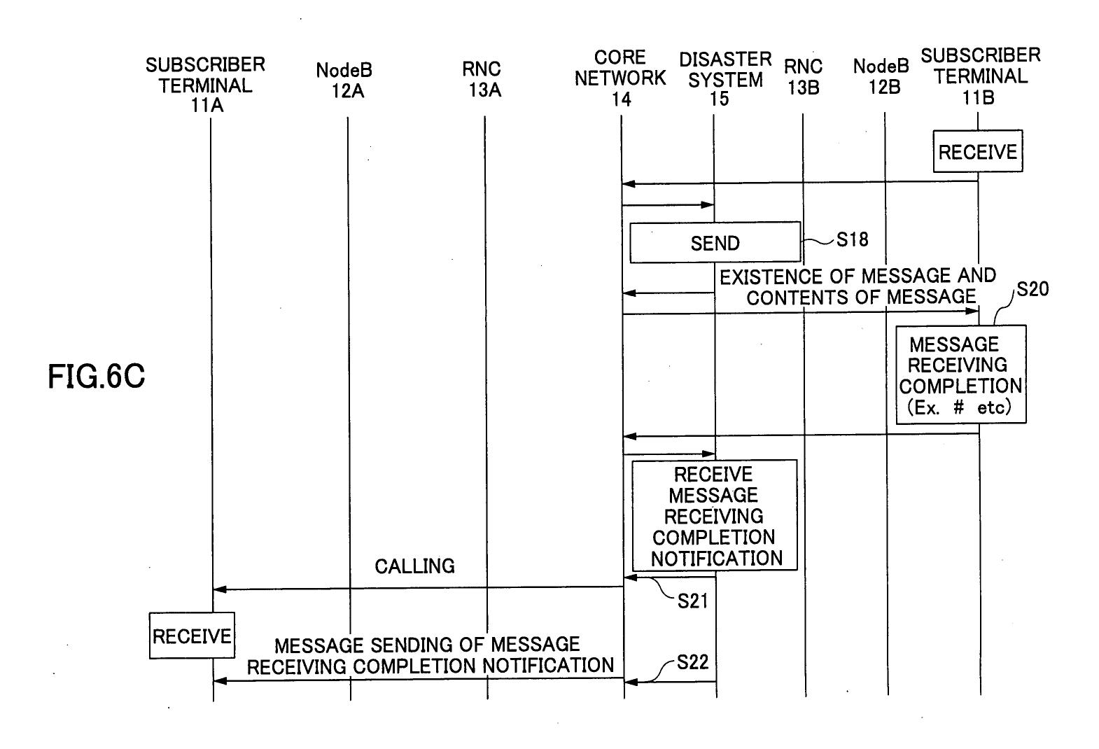

FIG. 6 is a diagram of sequence between devices of an example where “(1-1) Connect to disaster message service” is selected by the subscriber.

If the subscriber selects the message service, the subscriber terminal 11A sends information of “message service special number+receiving subscriber number B” from the core network 14 to the disaster system (message service system control part 75) (Step 11).

The disaster system sends a message which encourages the subscriber terminal 11A to start messaging (Step 12).

A message encouraging the start of the message is shown by the subscriber terminal 11A. Alternatively, as the message is shown, an indication encouraging the start of the message is displayed on the screen of the subscriber terminal 11A (Step 13).

If the message is left by the subscriber terminal 11A, the message is sent to the disaster system (message service system control part) (Step 14).

In the disaster system (message service system control part 75), the message of the subscriber terminal 11A is stored as a message for the subscriber terminal 11B, based on the information of the received subscriber number B being sent in advance in the step 11 (Step 15).

In the disaster system, access to the core network 14 is periodically performed so that monitoring information of the congestion state or lifting of the restriction of the cell, the cell being a subject of the restriction, is obtained (Step 16).

In a case where the restriction or the congestion state is eased, the disaster system (message service system control part) calls the subscriber terminal 11B (Step 17).

If the subscriber terminal 11B receives the calling, the disaster system (message service system control part) notifies the subscriber terminal 11B about the existence of the message and contents of the message to the subscriber terminal 11B. In order to let the subscribe terminal 11A know that the message is surely heard, the disaster system (message service system control part) notifies the subscriber terminal 11B that a specific key such as “#” should be pushed as the message receipt completion after the message is heard (Step 18).

In a case where the terminal subscriber 11B does not receive the calling, the disaster system (message service system control part 75) repeats the operations of the steps 16 and 17 until the subscriber receives the calling and the message sending completion notification is received (Step 19).

After the subscriber terminal 11B hears the message, a specific key such as “#” is pushed as the message receipt completion (Step 20).

The disaster system (message service system control part) calls the subscriber terminal 11A after receiving the message receiving completion notification (Step 21).

If the subscriber terminal 11A receives the calling, the disaster system (message service system control part) reports that the message is surely received by the subscriber terminal 11B (Step 22).

If the subscriber terminal 11A does not receive the calling, the disaster system (message service system control part) repeats the operations of step 21 and step 22.

### <(1-2) Access to Disaster Web Site>

Access from the subscriber terminal 11A to the disaster Web site, namely the disaster Web site system control part 90 of the disaster system 15, is automatically done.

The subscriber terminal 11A can input character data or voice data to the disaster Web site. Such data are stored in the database 80 as data for the subscriber terminal 11B. The disaster system 15 periodically monitors lifting of the calling restriction and the congestion state. When the congestion or the restriction is eased, the disaster Web site contacts the subscriber terminal 11B by a short-email so as to report that there is the message.

As a result of this, the subscriber terminal 11B accesses to the disaster web site indicated in the short e-mail so as to indicate the message or reproduce the contents of the message by voice. If the subscriber terminal 11B does not correspond to the contact from the disaster Web site, the disaster Web site periodically repeats contacting until the subscriber terminal 11B corresponds to the contact from the disaster Web site.

After the subscriber terminal 11B displays the message, if a message receiving completion button is pushed, the subscriber terminal 11A is notified by the disaster Web site that the subscriber terminal 11B surely hears the message.

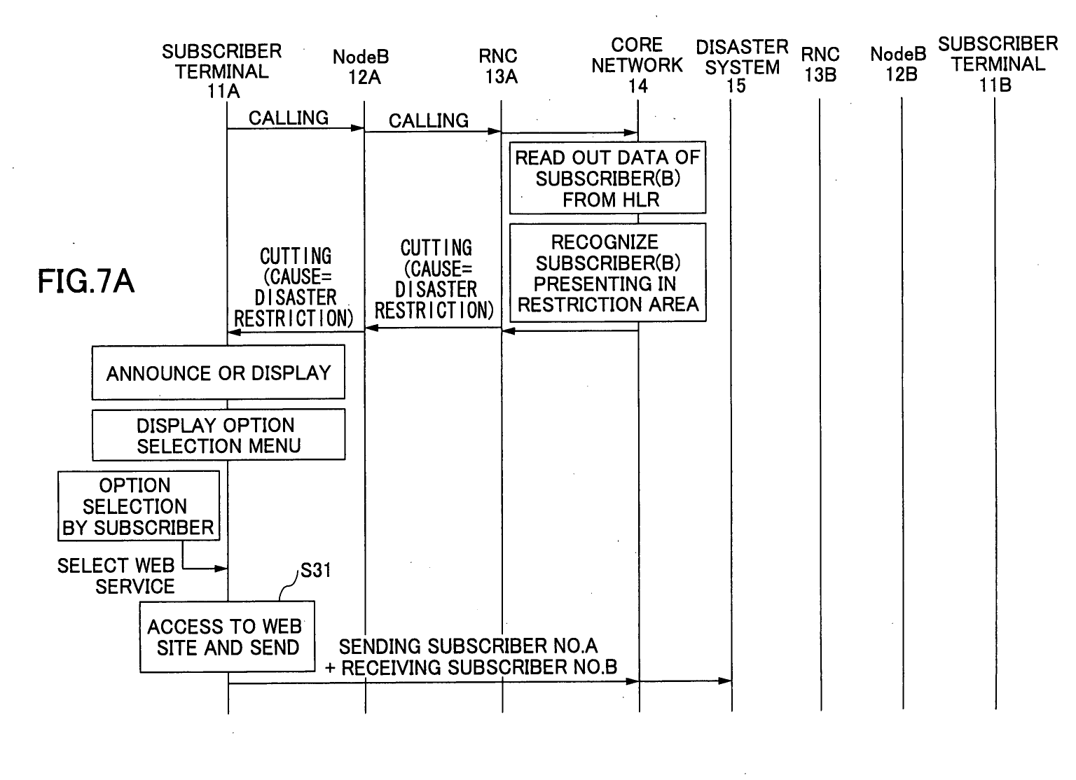

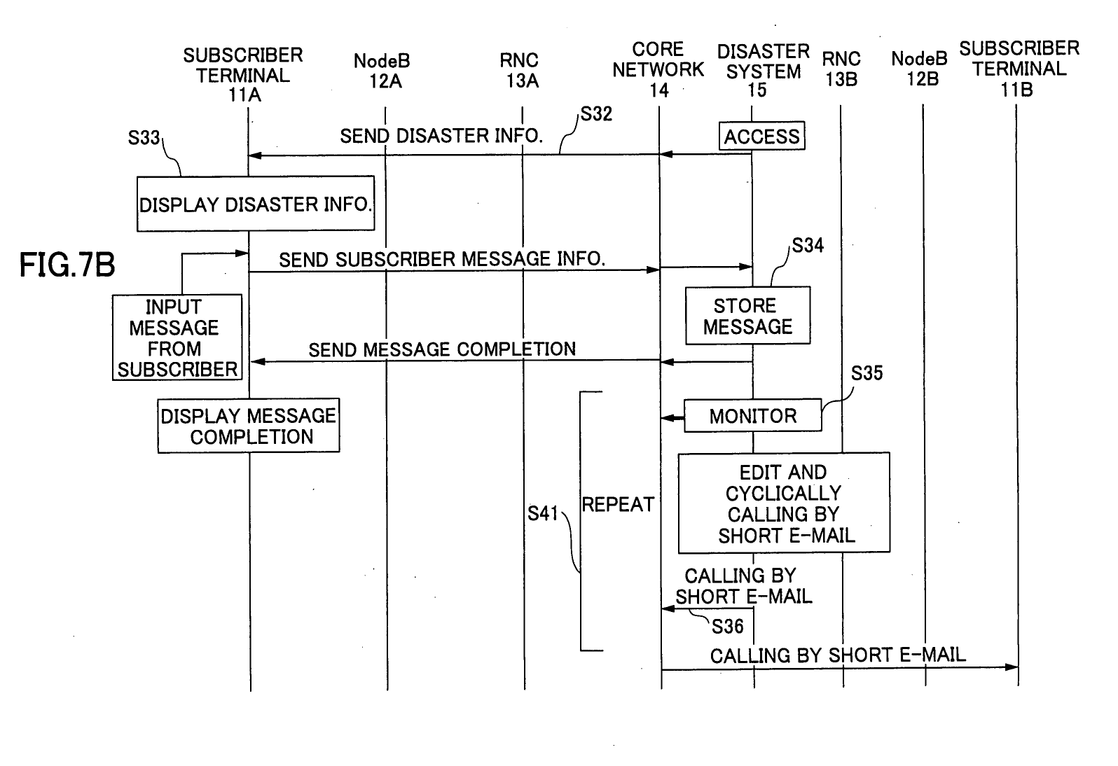

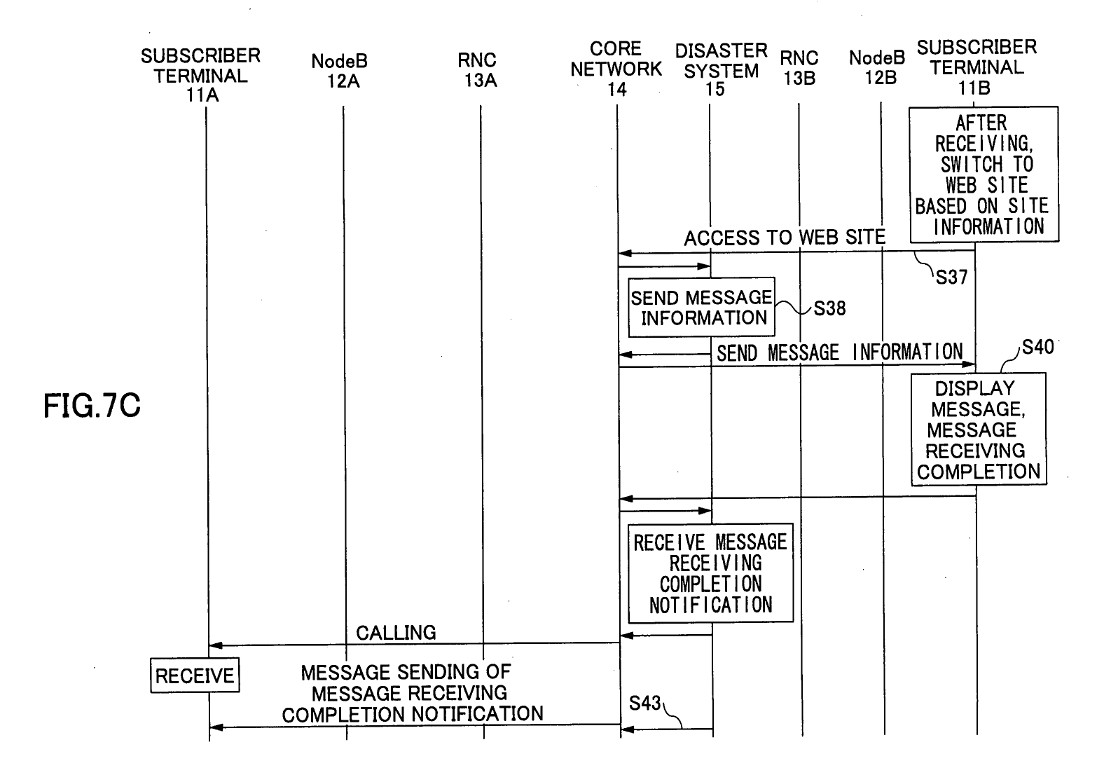

FIG. 7 is a diagram of sequence between devices of an example where “(1-2) Access to disaster Web site” is selected by the subscriber.

In a case where the subscriber selects the access to the disaster Web site, the subscriber terminal 11A sends information of “sending subscriber number A and receiving subscriber number B” from the core network 14 to the disaster system (disaster Web site system control part 90) (Step 31).

The disaster system sends the disaster site information to the subscriber terminal 11A (Step 32).

The disaster site information is displayed on the screen of the subscriber terminal. If the subscriber terminal 11A leaves the message by inputting voice or characters from a message input part on the screen, the input information is sent to the disaster system (disaster Web site system control part 90) (Step 33).

In the disaster system (disaster Web site system control part 90), the message of the subscriber terminal 11A is stored, by a process in step 31, as the message to the subscriber terminal 11B, based on the information of the receiving subscriber number B having been sent in advance (Step 34).

The disaster system periodically accesses to the core network 14 so as to obtain monitoring information of the lifting of the restriction of the cell that is a subject of the restriction or monitoring information of the congestion state (Step 35).

When the ease of the congestion or the restriction is made, the disaster system (disaster Web site system control part 90) edits access site address information and the sending subscriber number, and calls the subscriber terminal 11B by a short-email to notify that there is a message from the sending subscriber number (Step 36).

After receiving the e-mail, the subscriber terminal 11B accesses the site address indicated in the short e-mail (Step 37).

The disaster system (disaster Web site system control part 90) sends the contents of the message to the subscriber terminal 11B (Step 38).

The contents of the message are indicated on the screen of the subscriber terminal 11B. After the message is read, a completion button of the subscriber terminal 11B is pushed as message receiving completion (Step 40).

If the subscriber terminal 11B does not receive the short email, the disaster system (disaster Web site system control part 90) repeats the operations of step 35 and step 36 until the subscriber terminal 11B receives the short e-mail and the disaster system (disaster Web site system control part 90) receives the message sending completion notification from the subscriber terminal 11B (Step 41).

The disaster system (message service system control part 75) calls the subscriber terminal 11A after receiving the message receiving completion notification (Step 42).

If the subscriber terminal 11B receives the calling, the disaster system (disaster Web site system control part 90) reports that the message is surely received by the subscriber terminal 11B (Step 43).

If the subscriber terminal 11B does not receive the calling, the disaster system (disaster Web site system control part 90) repeats the operations of step 42 and step 43.

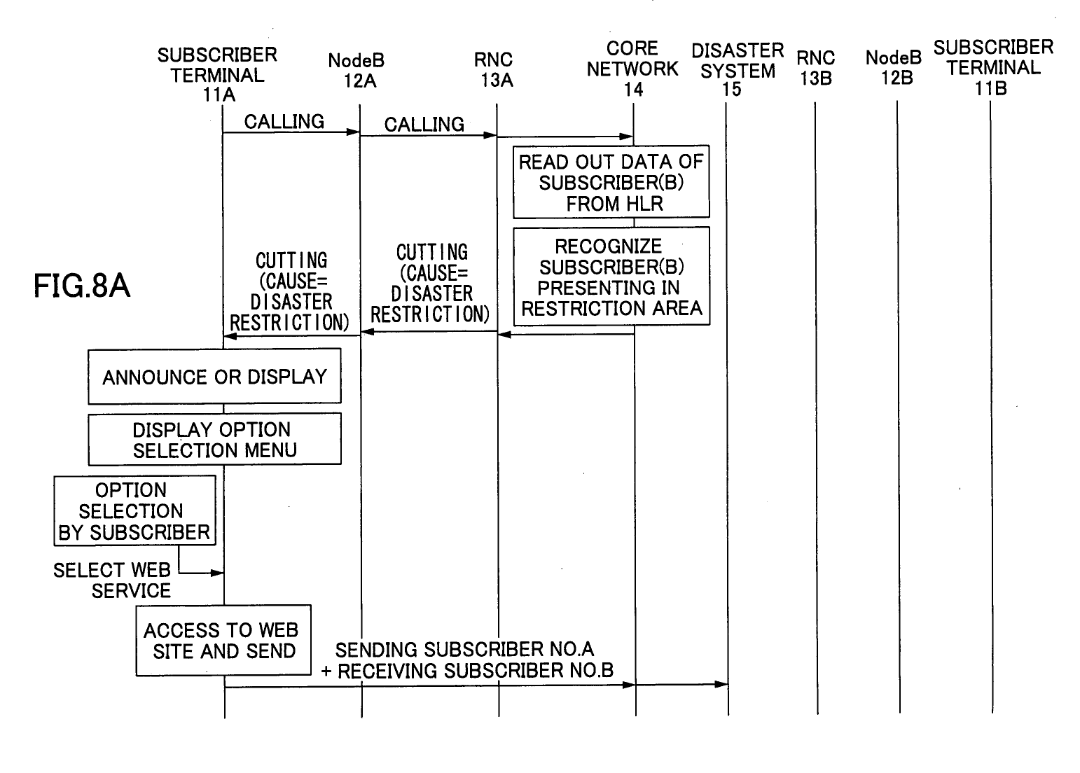

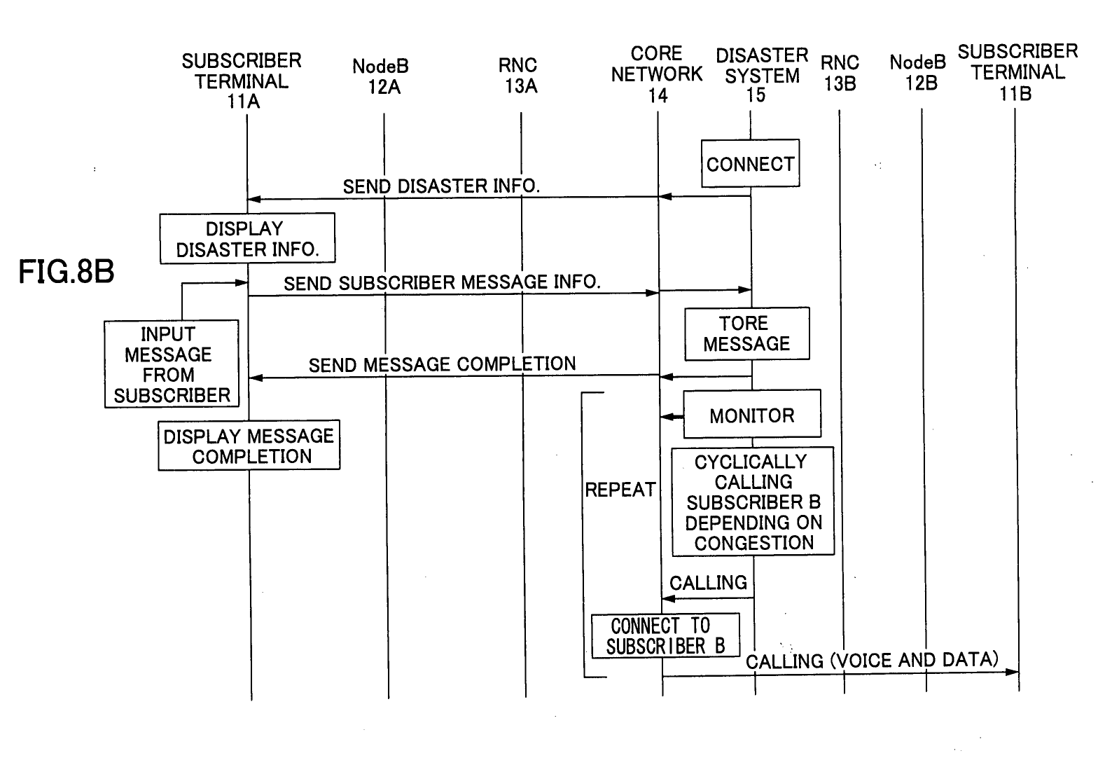

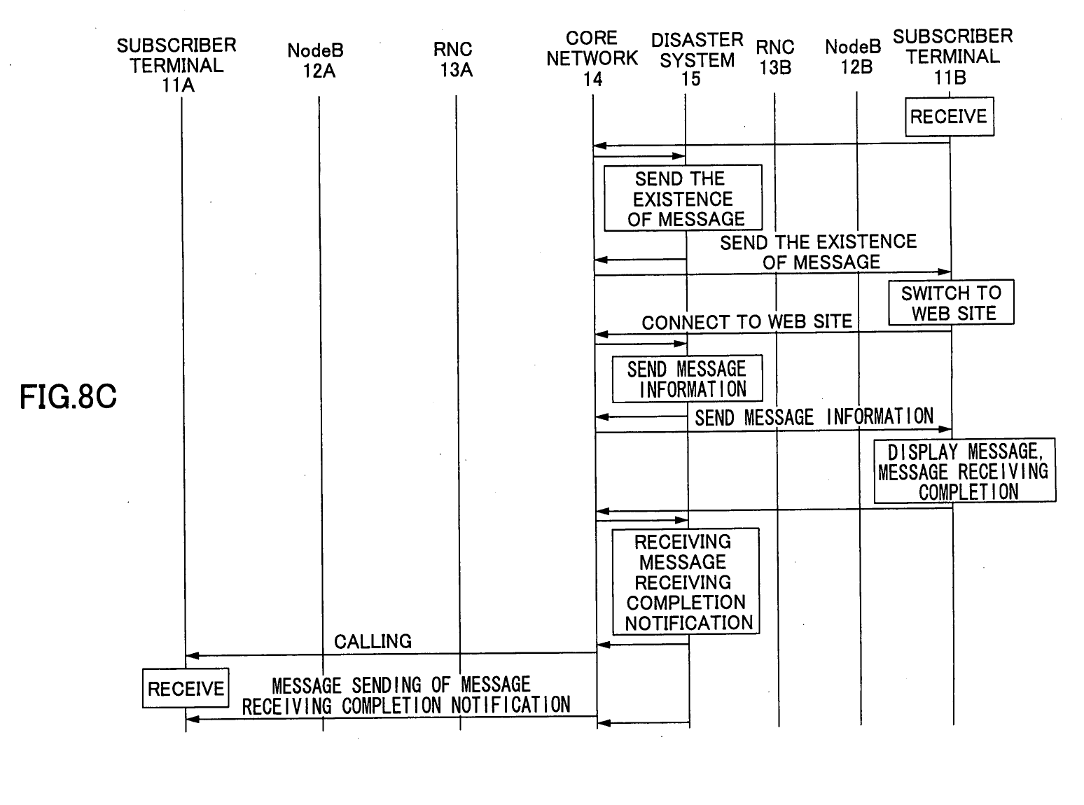

In the example shown in FIG. 7, a method wherein calling is made by the short e-mail from the disaster Web site to the subscriber terminal 11B and the site information to be accessed by the subscriber terminal 11B is provided in the short e-mail, is discussed. However, the present invention can be applied to an example shown in FIG. 8.

Referring to FIG. 8, voice calling of the message and data calling of the site information to be accessed by the subscriber terminal 11B are simultaneously made so that both the existence of the message to the subscriber terminal 11B and the site information are sent from the disaster Web site to the subscriber terminal 11B.

In this case, after implementation of automatic switching to the disaster Web site is communicated to the subscriber terminal 11B, based on the information of disaster data in the received data, automatic access to the site information is made.

In addition, when the contents of the message are sent, not the character data but voice discussed below may be sent. In a case where the contents of the message are the voice data, the contents of the message to the subscriber terminal 11B are sent by voice. In a case where the contents of the message are the characters data, the character data are converted to voice by the disaster system (disaster Web site system control part 90) so that the contents of the message to the subscriber terminal 11B are sent by voice.

### <(1-3) Switch to E-Mail Function>

In a case where the subscriber terminal 11A selects “(1-3) Switch to e-mail function”, if the e-mail address of the subscriber terminal 11B is registered, the subscriber terminal 11A switches to an e-mail editing screen of an e-mail format designating the e-mail address. If the e-mail address of the subscriber terminal 11B is not registered, the subscriber terminal 11A switches to an e-mail editing screen of a short e-mail format. A message is input and sent by the e-mail function so that the notification is sent to the subscriber terminal 11B.

The e-mail is sent as an emergency e-mail. For example, in the case of the short e-mail, even if the subscriber terminal 11B is in a short e-mail refusal mode, the notification is made to the subscriber terminal 11B as emergency e-mail. The contents of the e-mail are simultaneously sent to the disaster system 15 so as to be stored in the database 80 by the e-mail receiving and storing part 107. In a case where the subscriber terminal 11B opens the received e-mail, the e-mail notification completion control part 108 automatically generates an e-mail confirmation completion e-mail so as to send it to the subscriber terminal 11A.

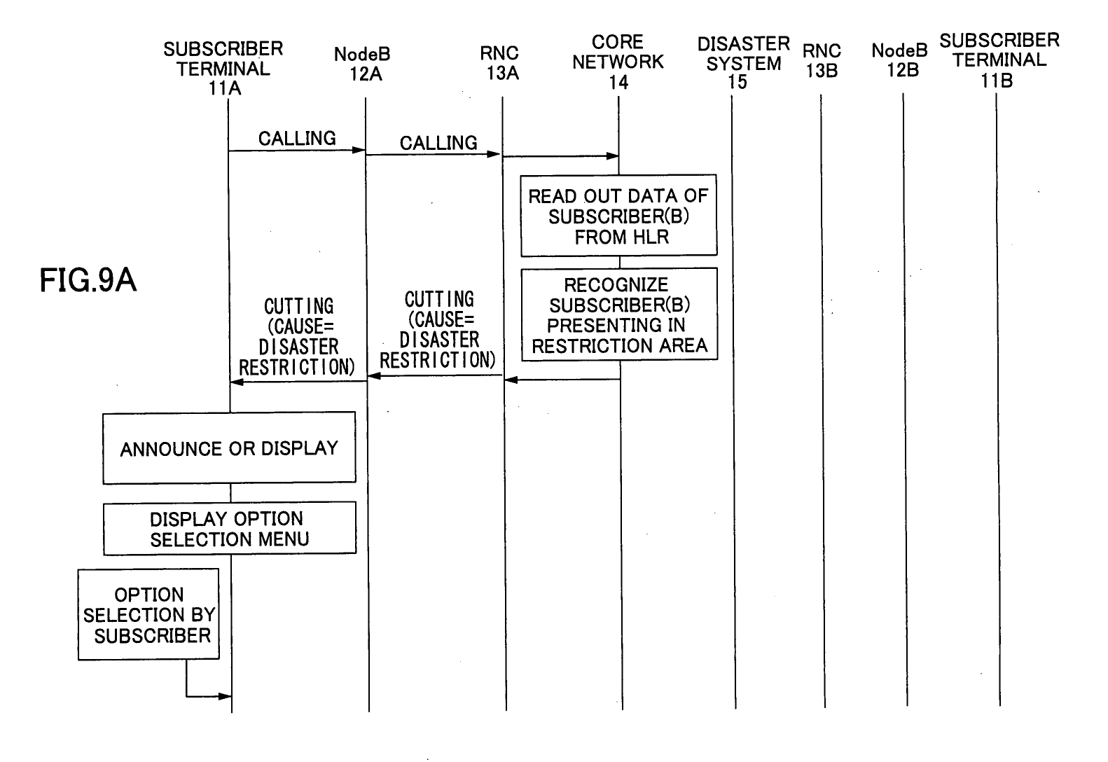

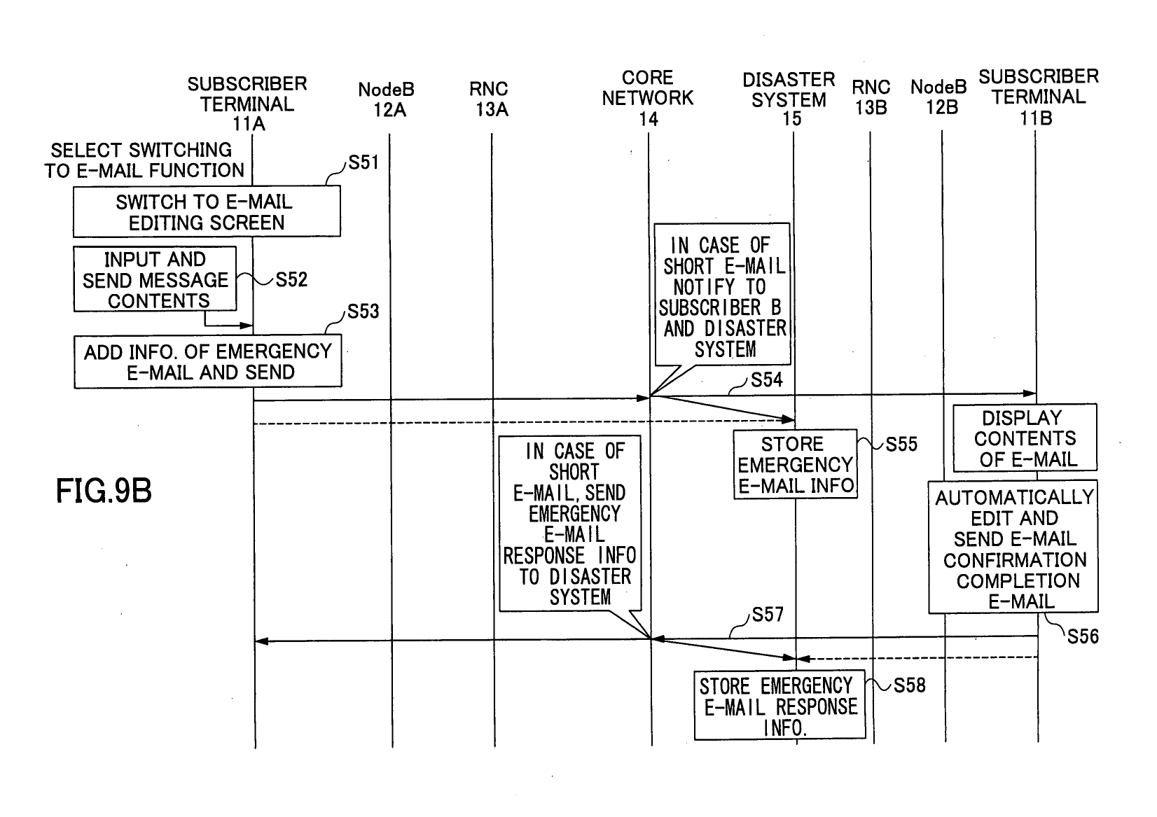

FIG. 9 is a diagram of sequence between devices of an example where “(1-3) Switch to e-mail function” is selected by the subscriber.

In a case where the subscriber terminal 11A selects “(1-3) Switch to e-mail function”, if the e-mail address of the subscriber terminal 11B is registered, the subscriber terminal 11A switches to an e-mail editing screen of an e-mail format designating the e-mail address. If the e-mail address of the subscriber terminal 11B is not registered, the subscriber terminal 11A switches to an e-mail editing screen of a short e-mail format. In a case of the e-mail format, in addition to the e-mail address of the subscriber terminal 11B, the e-mail address of the disaster system is simultaneously designated (step 51).

The subscriber terminal 11A inputs and sends the message by the e-mail function (step 52).

The subscriber terminal 11A adds information of the emergency e-mail and sends the contents of the e-mail (step 53).

For example, in the case of the short e-mail, even if the subscriber terminal 11B is in a short e-mail refusal mode, since the e-mail is an emergency e-mail, the core network 14 sends the contents of the e-mail to the subscriber terminal 11B. In addition, in the case of the short e-mail address, the core network 14 sends the information of the corresponding emergency e-mail to the disaster system (step 54).

When receiving the emergency e-mail, the disaster system 15 stores corresponding information in the database 80 (step 55).

The subscriber terminal 11B receives the e-mail and displays the contents of the e-mail (and indicates that the e-mail is an emergency e-mail). When the e-mail is opened, the subscriber terminal 11B automatically edits the e-mail confirmation completion e-mail and automatically sends it to the sender (step 56).

In the case of the short e-mail address, the core network 14 sends the e-mail response information to the disaster system 15 (step 57).

In a case where the disaster system receives the response to the emergency e-mail, the disaster system stored corresponding information in the database 80 (step 58).

As discussed above, in step 51, in the case of the e-mail format, in addition to the e-mail address of the subscriber terminal 11B, the e-mail address of the disaster system is simultaneously designated. As well as the case of the short e-mail, the core network 14 may send the information of the corresponding emergency e-mail to the disaster system.

In the case where the e-mail address of the disaster system is simultaneously designated by the subscriber terminal 11A, it is necessary to install an e-mail address of the disaster system defined in advance in the subscriber terminal. In order to correspond to the change of the e-mail address, it is preferable to have a system whereby newest information therein can be downloaded.

### <2. Automatically (Forcibly) Performing the Alternative Method Instead of the Telephone Call.>

In a case where the subscriber terminal 11A calls the subscriber terminal 11B, the subscriber terminal 11B being restricted due to the disaster, the core network 14 does not forcibly restrict the calling and voice announcement to the subscriber terminal 11A such as “Since calling is restricted due to the generation of disaster, your calling is automatically connected to the message service” is made. Thus, the subscriber terminal 11A is notified that the message t-o the subscriber terminal 11B is left by using the message service system and connected to the message service system.

The message service control part 76 announcement is to encourage the subscriber terminal 11A to start leaving a message. If message is left by the subscriber terminal 11A, the message service system control part 76 stores the message from the subscriber terminal 11A in the database 80 as a message to the subscriber terminal 11B.

The disaster system 15 lifts the calling restriction and periodically monitors the congestion state. If the congestion is eased, the message service system calls the subscriber terminal 11B so as to communicate the existence of the message and contents of the message. If the subscriber terminal 11B does not correspond to the calling, the calling is periodically repeated until the subscriber terminal 11B corresponds to the calling.

After the subscriber terminal 11B hears the message, if a specific key such as “#” is pushed, it is reported that the subscriber terminal 11B surely hears the message, from the message service system to the subscriber terminal 11A.

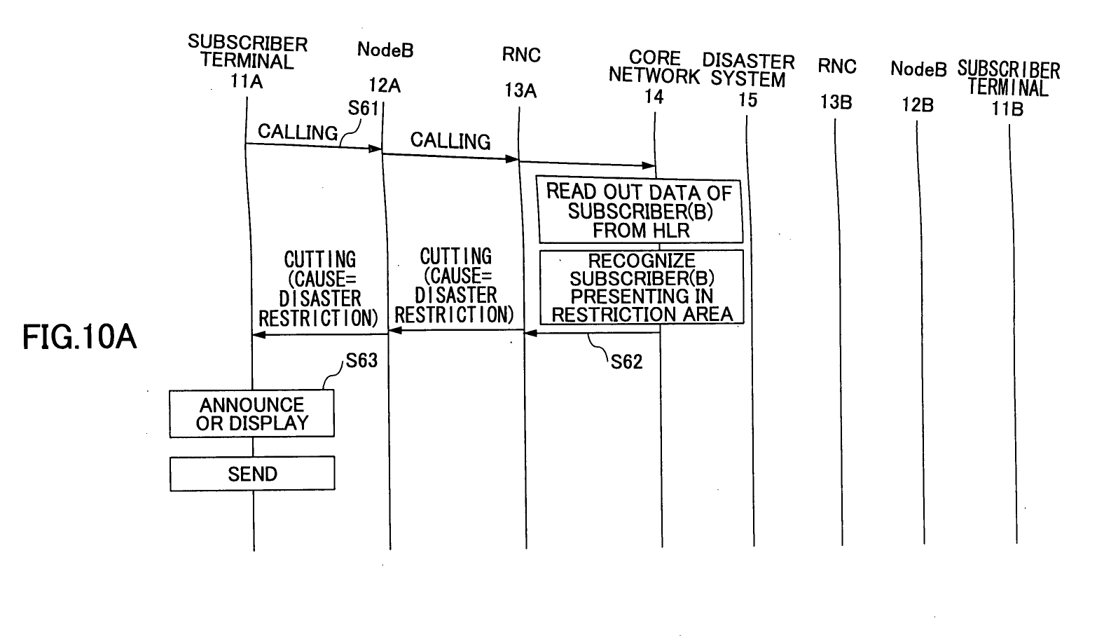

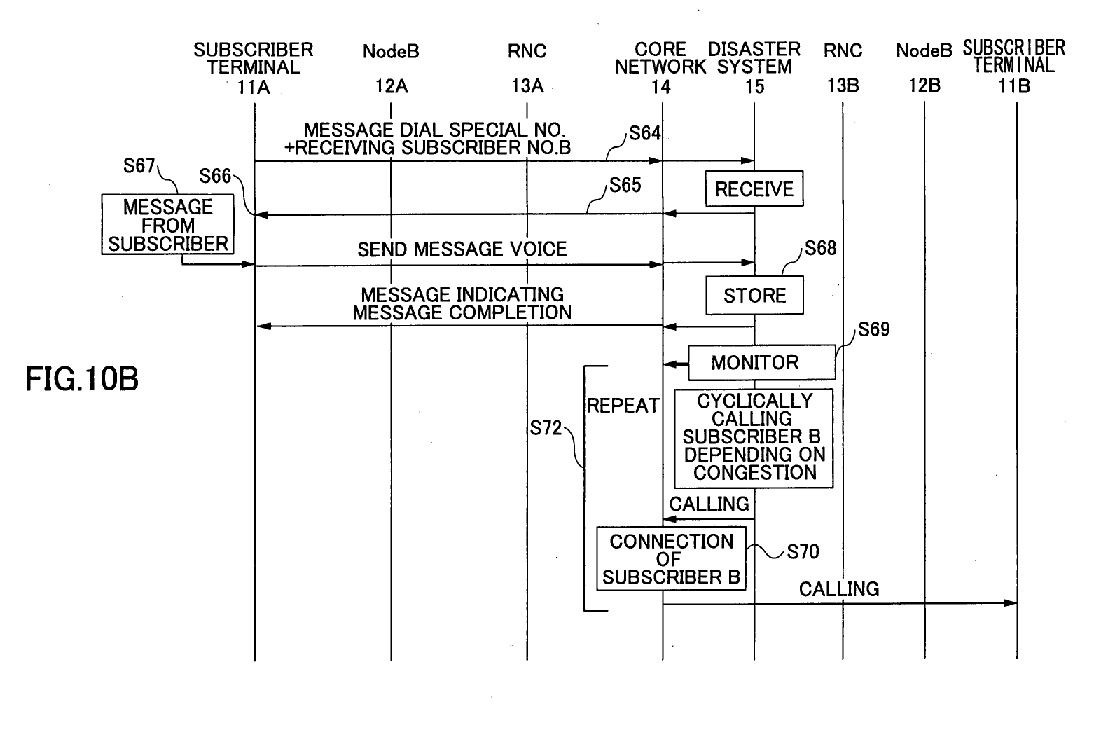

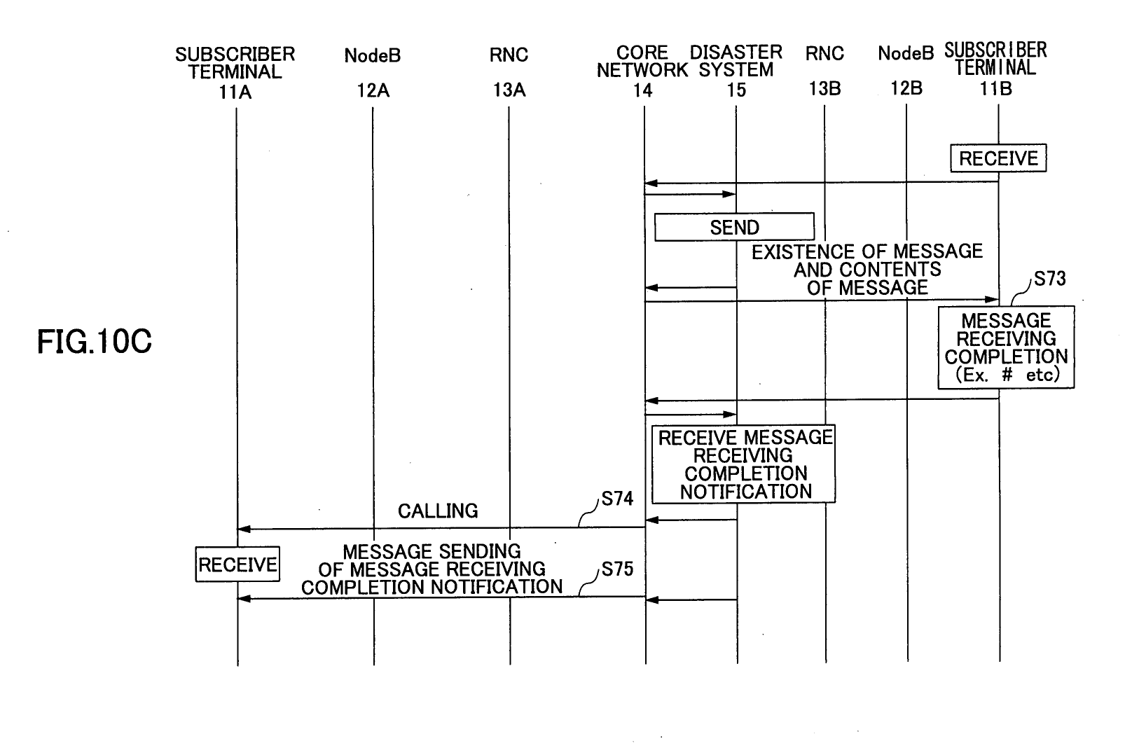

FIG. 10 is a diagram of sequence between devices of an example for automatically connecting to disaster message service.

If the subscriber terminal 11A calls the subscriber terminal 11B, a calling signal is sent by the subscriber terminal 11A, the radio base station 12A, the radio network control device 13A, and the core network 14, in this order (Step 61).

In the core network 14, based on the input from a maintenance console or notification from a subordinate device, information of the restricted cell (RNC number+Node B number, cell number) is recognized in advance. In the core network 14 receiving the calling signal, the cell in which the subscriber terminal 11B presently is found by using the receiving subscriber number and that connection cannot be made due to the restriction are communicated to the subscriber terminal 11A (Step 62).

The subscriber terminal 11A receiving the notification does not output a normal busy tone. The subscriber terminal 11A activates the disaster steps and announces to the subscriber that the phone call by the voice cannot be done and calling is automatically connected to the message service. Alternatively, that the phone call by voice cannot be done and calling is automatically connected to the message service is displayed on the screen of the subscriber terminal 11A (Step 63).

The subscriber terminal 11A sends information of “message service special number+receiving subscriber number B” from the core network 14 to the disaster system (message service system control part 75) (Step 64).

The disaster system 15 sends a message which encourages the subscriber terminal 11A to start messaging (Step 65).

A message encouraging the start of the message is shown by the subscriber terminal 11A. Alternatively, as the message is shown, an indication encouraging the start of the message is displayed on the screen of the subscriber terminal 11A (Step 66).

If the message is left by the subscriber terminal 11A, the message is sent to the disaster system (message service system control part) (Step 67).

In the disaster system (message service system control part 75), the message of the subscriber terminal 11A is stored as a message for the subscriber terminal 11B, based on the information of the received subscriber number B being sent in advance in step 64 (Step 68).

In the disaster system, access to the core network 14 is periodically performed so that monitoring information of the congestion state or lifting of the restriction of the cell that is a subject of the restriction is obtained (Step 69).

In a case where the restriction or the congestion state is eased, the disaster system (message service system control part) calls the subscriber terminal 11B (Step 70).

If the subscriber terminal 11B receives calling, the disaster system (message service system control part) notifies the subscriber terminal 11B about the existence of the message and contents of the message to the subscriber terminal 11B. (Step 71).

In a case where the terminal subscriber 11B does not receive the calling, the disaster system (message service system control part 75) repeats the operations of the steps 74 and 75 until the subscriber receives the calling and the message sending completion notification is received (Step 72).

After the subscriber terminal 11B hears the message, a specific key such as “#” is pushed as the message receipt completion (Step 73).

The disaster system (message service system control part) calls the subscriber terminal 11A after receiving the message receiving completion notification (Step 74).

If the subscriber terminal 11A receives the calling, the disaster system (message service system control part) communicates that the message is surely received by the subscriber terminal 11B (Step 75).

If the subscriber terminal 11A does not receive the calling, the disaster system (message service system control part) repeats the operations of step 74 and step 75.

Next, an example where automatic access to the disaster Web sire is made is discussed.

In a case where the subscriber terminal 11A calls the subscriber terminal 11B that is restricted due to the stricken disaster, calling is not forcibly restricted and voice announcement to the subscriber terminal 11A such as “Since calling is restricted due to the generation of disaster, your calling is automatically connected to the message service” is made. Connection to the disaster Web site, namely a disaster Web site system control part 90 of the disaster system 15 is made so that the disaster menu is displayed on the subscriber terminal 11A.

The subscriber terminal 11A can input character data or voice data to the disaster Web site. Such data are stored in the database 80 as data to the subscriber terminal 11B. The disaster system 15 periodically monitors lifting of the calling restriction and the congestion state. When the congestion or the restriction is eased, the disaster Web site contacts the subscriber terminal 11B by a short-email so as to notify that there is the message.

As a result of this, the subscriber terminal 11B accesses the disaster Web site indicated in the short e-mail so as to display the message or reproduce the contents of the message by voice. If the subscriber terminal 11B does not correspond to the contact from the disaster Web site, the disaster Web site periodically repeats contacting until the subscriber terminal 11B corresponds to the contact from the disaster Web site.

After the subscriber terminal 11B finds the indicated message, if a message receiving completion button is pushed, the subscriber terminal 11A is notified by the disaster Web site that the subscriber terminal 11B surely hears the message.

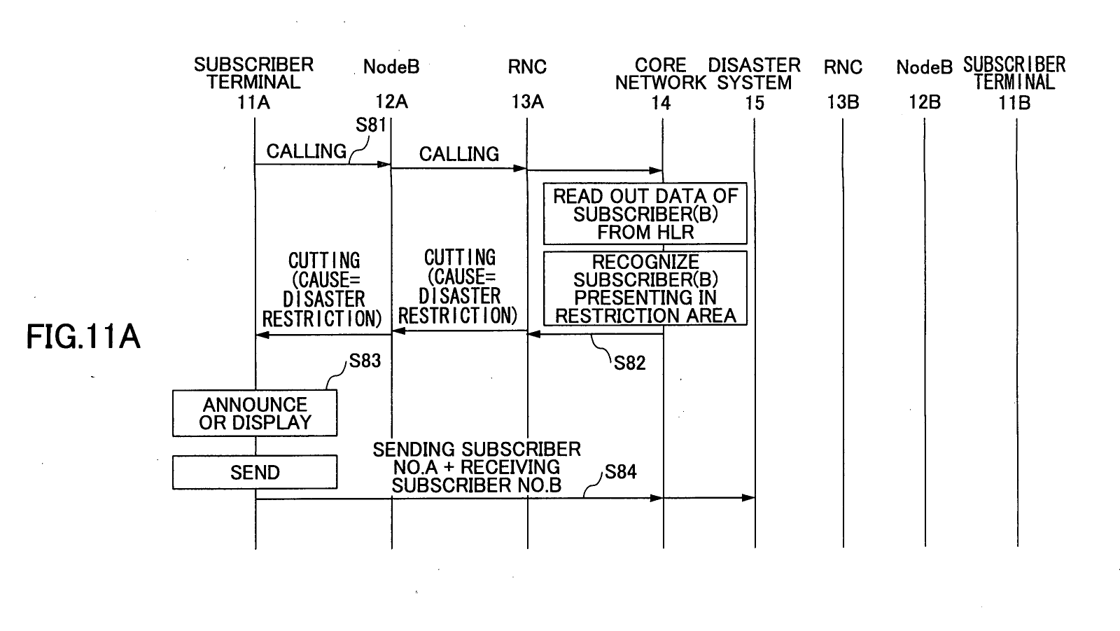

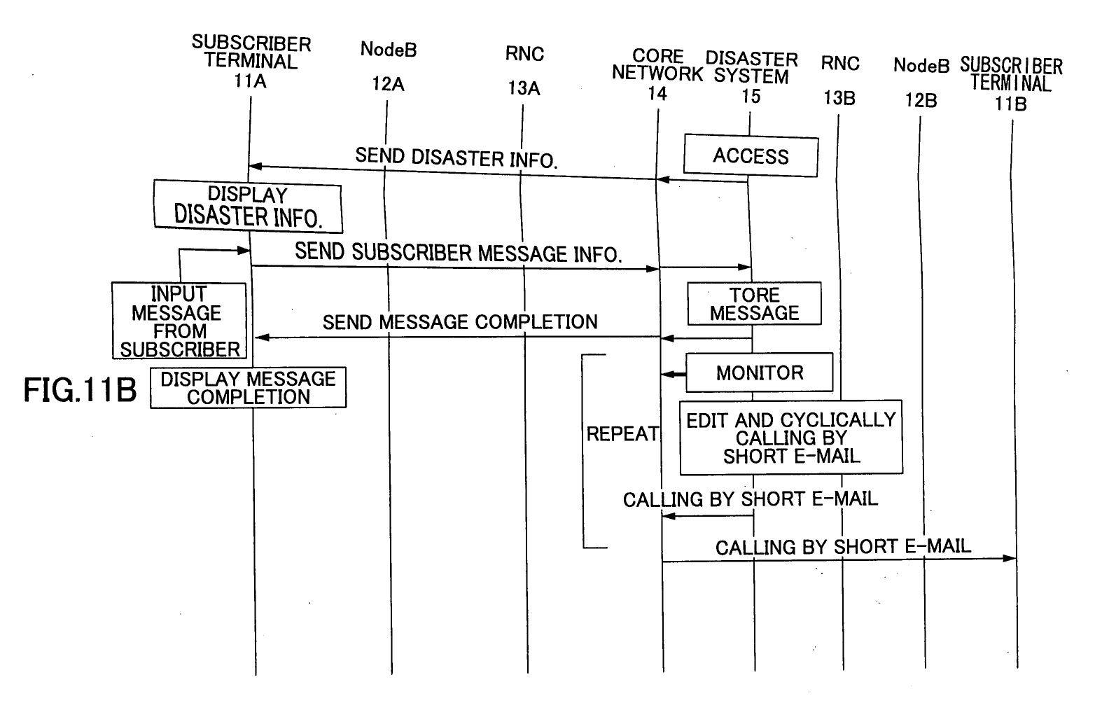

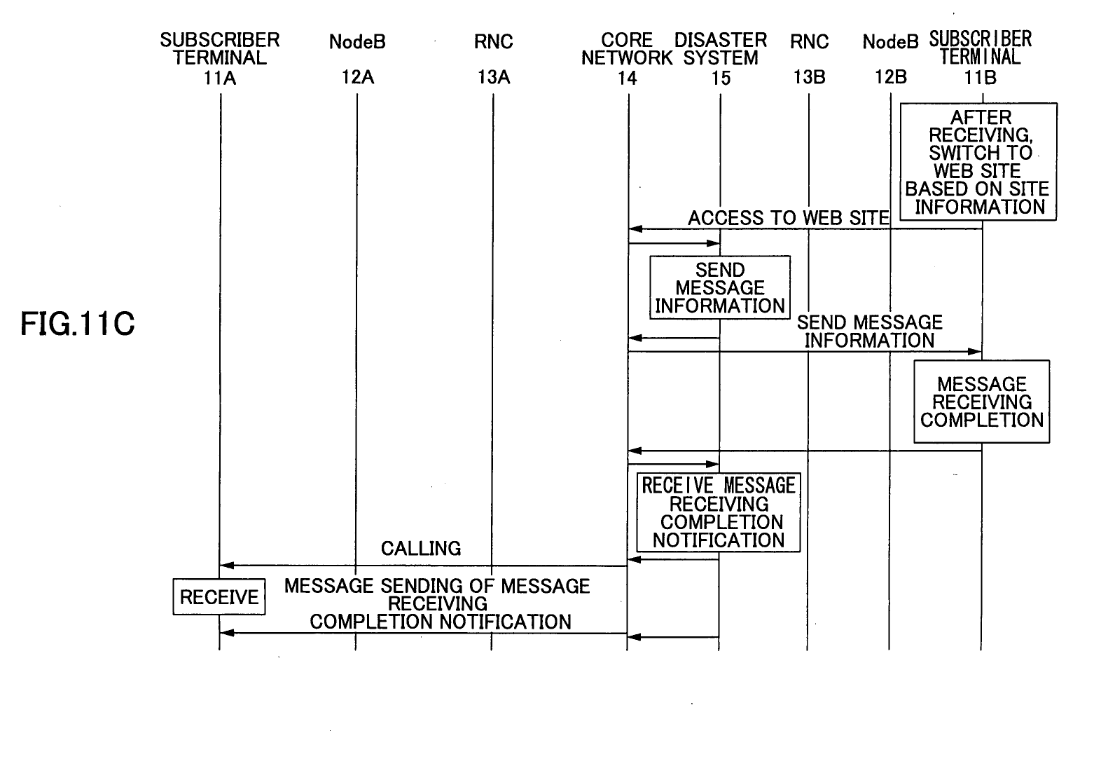

FIG. 11 is a diagram of sequence between devices of an example for automatically accessing a disaster Web site.

If the subscriber terminal 11A calls the subscriber terminal 11B, a calling signal is sent by the subscriber terminal 11A, the radio base station 12A, the radio network control device 13A, and the core network 14, in this order (Step 81).

In the core network 14, based on the input from a maintenance console or notification from a subordinate device, information of the restricted cell (RNC number+Node B number, cell number) is recognized in advance. In the core network 14 receiving the calling signal, the cell in which the subscriber terminal 11B presently is found by using the receiving subscriber number and that connection cannot be made due to the restriction are communicated to the subscriber terminal 11A (Step 82).

The subscriber terminal 11A receiving the notification does not output a normal busy tone. The subscriber terminal 11A activates the disaster steps and announces to the subscriber that the phone call by voice cannot be done and calling is automatically connected to the disaster Web site. Alternatively, that the phone call by voice cannot be done and calling is automatically connected to the disaster Web site is displayed on the screen of the subscriber terminal 11A (Step 83).

The subscriber terminal 11A sends information of “message service special number+receiving subscriber number B” from the core network 14 to the disaster system (message service system control part 90) (Step 84). After this step, the same process is applied as in the process shown in FIG. 7 and therefore explanation thereof is omitted.

Next, an example for automatically switching to the main function is discussed.

In a case where the subscriber terminal 11A calls the subscriber terminal 11B that is restricted due to the disaster, calling is not forcibly restricted but the following operations can be done.

### (1) That connection of the voice calling is restricted due to the disaster restriction and switched to the e-mail function is communicated.

(2) If the e-mail address of the subscriber terminal 11B is registered, the subscriber terminal 11A switches to an e-mail editing screen of an e-mail format designating the e-mail address. If the e-mail address of the subscriber terminal 11B is not registered, the subscriber terminal 11A switches to an e-mail editing screen of a short e-mail format.

### (3) The subscriber terminal 11A inputs and sends the message by the e-mail function so that the notification is sent to the subscriber terminal 11B.

The e-mail is sent as an emergency e-mail. For example, in the case of the short e-mail, even if the subscriber terminal 11B is in a short e-mail refusal mode, the notification is made to the subscriber terminal 11B as emergency e-mail.

The contents of the e-mail are simultaneously sent to the disaster system 15 so as to be stored in the database 80. In a case where the subscriber terminal 11B opens the received e-mail, the e-mail confirmation completion e-mail is generated so as to be sent to the subscriber terminal 11A.

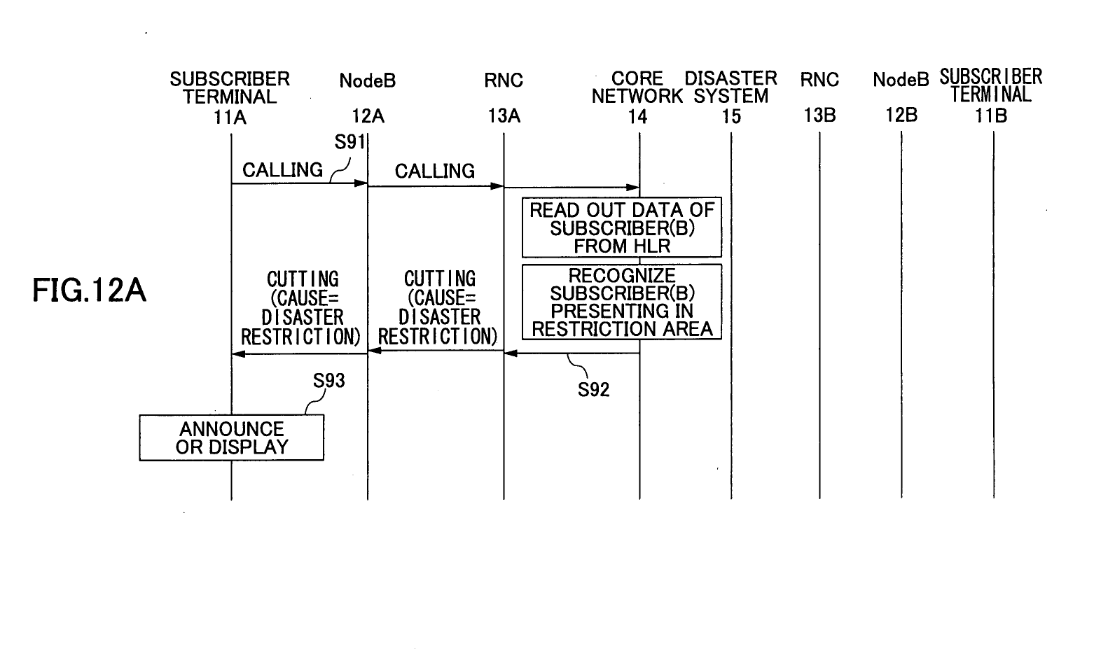

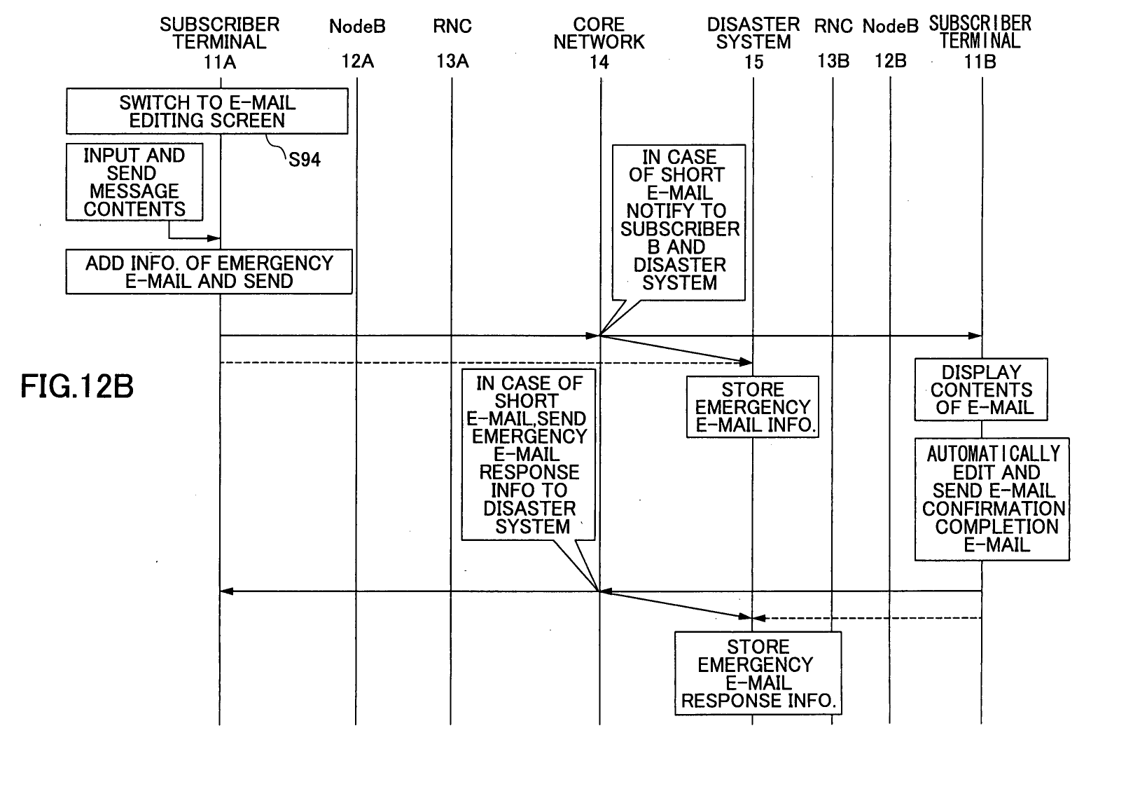

FIG. 12 is a diagram of sequence between devices of an example for automatically switching to an e-mail function.

If the subscriber terminal 11A calls the subscriber terminal 11B, a calling signal is sent by the subscriber terminal 11A, the radio base station 12A, the radio network control device 13A, and the core network 14, in this order (Step 91).

In the core network 14, based on the input from a maintenance console or notification from a subordinate device, information of the restricted cell (RNC number+Node B number, cell number) is recognized in advance. In the core network 14 receiving the calling signal, the cell in which the subscriber terminal 11B presently is found by using the receiving subscriber number and that connection cannot be made due to the restriction is communicated to the subscriber terminal 11A (Step 92).

The subscriber terminal 11A receiving the notification does not output a normal busy tone. The subscriber terminal 11A activates the disaster steps and announces to the subscriber that the phone call by voice cannot be done and calling is automatically connected to the e-mail editing screen. Alternatively, that the phone call by the voice cannot be done and calling is automatically connected to the e-mail editing screen is displayed on the screen of the subscriber terminal 11A (Step 93).

If the e-mail address of the subscriber terminal 11B is registered, the subscriber terminal 11A switches to an e-mail editing screen of an e-mail format designating the e-mail address. If the e-mail address of the subscriber terminal 11B is not registered, the subscriber terminal 11A switches to an e-mail editing screen of a short e-mail format. In a case of the e-mail format, in addition to the e-mail address of the subscriber terminal 11B, the e-mail address of the disaster system is simultaneously designated (step 94). After this step, the same process is applied as in the process shown in FIG. 9 and therefore explanation thereof is omitted.

### <Determine Alternative Method Instead of Calling, Depending on the Restriction State (Restriction Rate)>

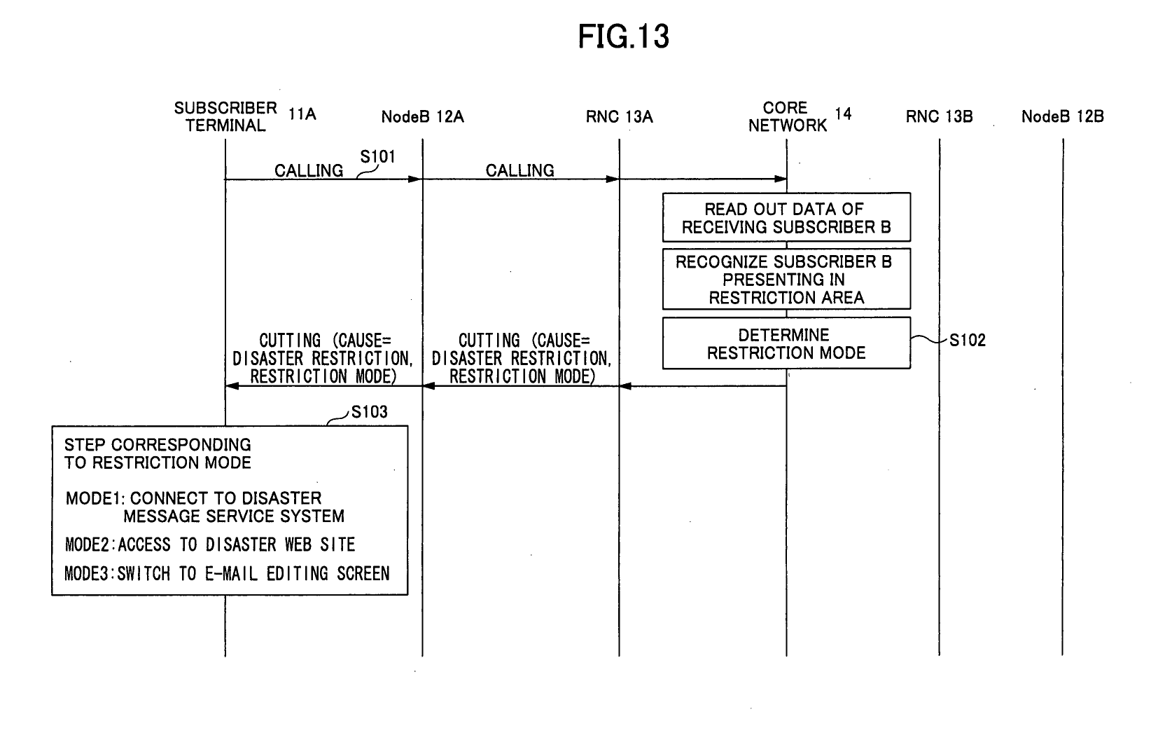

FIG. 13 is a diagram of sequence between devices of an example where an alternative method instead of calling is determined depending on the restriction state (restriction ratio).

If the subscriber terminal 11A calls the subscriber terminal 11B, a calling signal is sent by the subscriber terminal 11A, the radio base station 12A, the radio network control device 13A, and the core network 14, in this order (Step 101).

In the core network 14, based on the input from a maintenance console or notification from a subordinate device, information of the restricted cell (RNC number+Node B number, cell number) is recognized in advance. Simultaneously, a restriction ratio (x %) of voice calling and a restriction ratio (y %) of data communication are recognized in advance based on the input from the maintenance console or the notification from the subordinate device, so that the restriction mode is determined by the restriction ratios (Step 102).

For example, a mode 1 is determined when the restriction ratio of the voice calling is equal to or greater than a % (for example, a=60). A mode 2 is determined when the restriction ratio of the voice calling is equal to or greater than b % (for example, b=90) and the restriction ratio of the data communication is equal to or greater than c % (for example, c=50). A mode 3 is determined when the restriction ratio of the voice calling is equal to or greater than b % (for example, b=90) and the restriction ratio of the data communication is equal to or greater than d % (for example, d=70). The core network 14 receiving a calling signal finds the cell in which the subscriber terminal 11B is presently located via the receiving subscriber number so that that the connection cannot be made due to the restriction and the restriction mode are reported to the subscriber terminal 11A.

The subscriber terminal 11A receiving the notification does not output a normal busy tone. The subscriber terminal 11A activates the disaster steps and, by the restriction mode, determines one of which is implemented among “Automatically connect to the disaster message service system”, “Automatically access the disaster Web site” or “Automatically switch to the e-mail editing screen” (Step 103).

For example, in the case of the mode 1, connection to the disaster message service system may be the alternative method. In the case of the mode 2, access to the disaster Web site may be the alternative method. In the case of the mode 3, switching to the e-mail editing screen is the alternative method. After that, the steps corresponding to the method determined by the subscriber terminal 11A are implemented.

### <Determine an Alternative Method Which the Subscriber can Select, Depending on the Restriction State (Restriction Rate)>

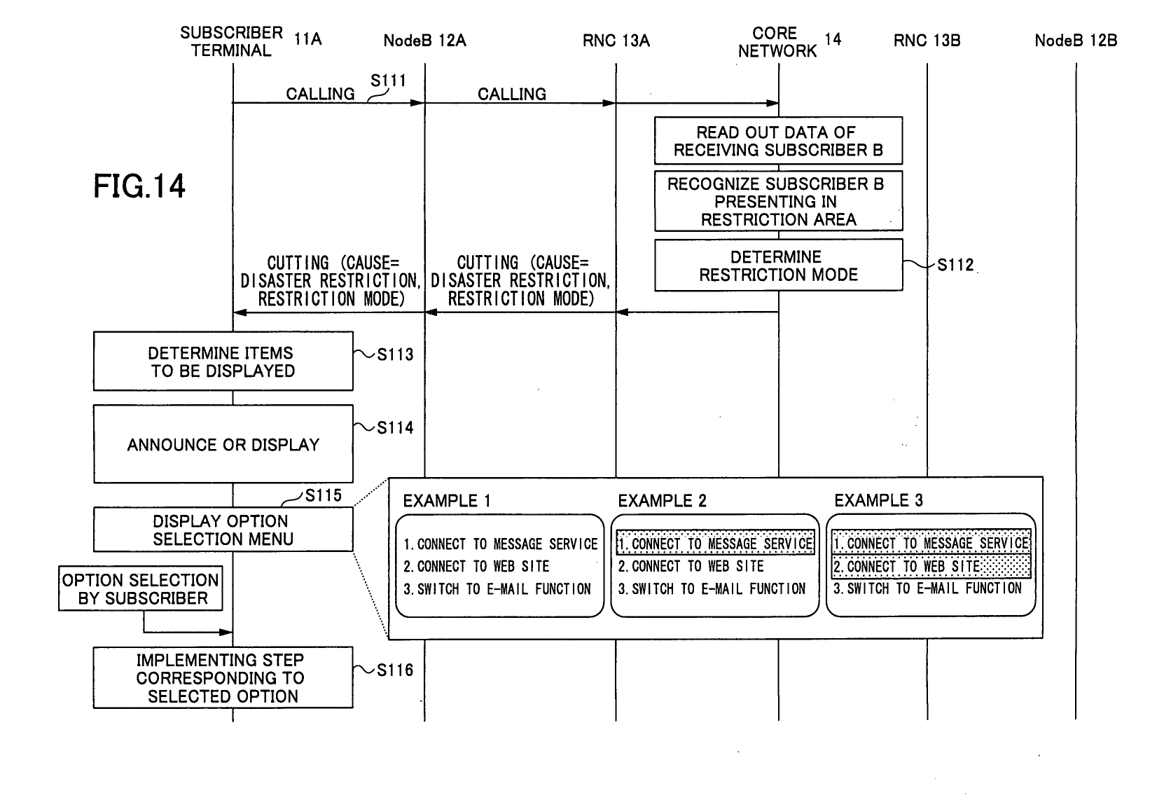

FIG. 14 is a diagram of sequence between devices of an example where there are alternative methods which the subscriber can select depending on the restriction state (restriction ratio).

If the subscriber terminal 11A calls the subscriber terminal 11B, a calling signal is sent by the subscriber terminal 11A, the radio base station 12A, the radio network control device 13A, and the core network 14, in this order (Step 111).

In the core network 14, based on the input from a maintenance console or notification from a subordinate device, information of the restricted cell (RNC number+Node B number, cell number) is recognized in advance. Simultaneously, a restriction ratio (x %) of voice calling and a restriction ratio (y %) of data communication are recognized in advance based on the input from the maintenance console or the notification from the subordinate device, so that the restriction mode is determined by the restriction ratios (Step 112).

For example, a mode 11 is determined when the restriction ratio of the voice calling is equal to or greater than 100%. A mode 12 is determined when the restriction ratio of the voice calling is equal to or less than d % (for example, d=70). A mode 13 is determined when the restriction ratio of the voice calling is equal to or greater than d % (for example, d=70). The core network 14 receiving a calling signal finds the cell in which the subscriber terminal 11B is presently located via the receiving subscriber number so that that connection cannot be made due to the restriction and the restriction mode are reported to the subscriber terminal 11A.

The subscriber terminal 11A receiving the notification does not output a normal busy tone. The subscriber terminal 11A activates the disaster steps and, by the restriction mode of voice calling, determines which should be displayed on the subscriber terminal screen as an option selection menu (Step 113).

For example, in the case of the mode 11, only “2. Access to the disaster Web site” and “3. Switch to the e-mail editing screen” can be selected (Example 2). In the case of mode 12, “1. Connect to the disaster message service system”, “2. Access to the disaster Web site” and “3. Switch to the e-mail editing screen” can be selected (Example 1). In the case of mode 13, only “3. Switch to the e-mail editing screen” can be selected (Example 3).

The subscriber terminal 11A announces that voice calling is not made or displays on the subscriber terminal screen that the voice calling is not made (Step 114).

An option selection menu of items determined in step 113 is displayed on the subscriber terminal screen so that the subscriber is encouraged to select the option. While the item which cannot be selected are displayed but cannot be selected in the example shown in FIG. 14, only the items which can be selected may be displayed.

With the option selection by the subscriber as a trigger, steps corresponding to the Options are taken in the subscriber terminal 11A (Step 116).

### <<When a Sender Side Presents in a Cell that is a Subject of the Restriction>>

A case where a sender side presents in a cell that is a subject of the restriction is discussed.

If the subscriber terminal 11A calls the subscriber terminal 11B, a calling signal is sent by the subscriber terminal 11A, the radio base station 12A, the radio network control device 13A, and the core network 14, in this order (First Step).

In the core network 14, based on the input from a maintenance console or notification from a subordinate device, information of the restricted cell (RNC number+Node B number, cell number) is recognized in advance. In the core network 14 receiving the calling signal, the cell in which the subscriber terminal 11B presently is found by using the receiving subscriber number and that connection cannot be made due to the calling restriction because the subscriber terminal 11B presently in the restriction area are communicated to the subscriber terminal 11A (Second Step).

The subscriber terminal 11A receiving the notification does not output a normal busy tone. The subscriber terminal 11A activates the disaster steps and the following four methods are implemented as well as the case where the subscriber terminal 11B is restricted (Third step). Embodiments are the same as the method discussed with reference to FIG. 5 through FIG. 14.

### (1) Alternative method instead of a telephone call can be selected.

### (2) Automatically (forcibly) performing the alternative method instead of the telephone call.

### (3) Automatically (forcibly) performing the alternative method instead of the telephone call as corresponding to a status of restriction (restriction rate).

### (4) Determining an alternative method that can be selected by the subscriber corresponding to the status of restriction.

In addition to this example, as a first step, if the subscriber terminal 11A calls the subscriber terminal 11B, a calling signal may be sent by the subscriber terminal 11A, the radio base station 12A, the radio network control device 13A, and the core network 14, in this order, and that the connection cannot be made due to the congestion of the radio network control device 13A is communicated to the subscriber terminal 11A.

As a second step, the subscriber terminal 11A receiving the notification does not output a normal busy tone. The subscriber terminal 11A may activate the disaster steps and the methods (1) through (4) may be implemented as well as a case where the subscriber terminal 11B is restricted.

According to the embodiment of the present invention, in a case where the sending (calling) subscriber does not recognize that the receiving Subscriber is restricted due to the disaster, by making the sending subscriber recognize this and providing a contact method such as an e-mail or message other than voice calling to the sending subscriber, it is possible to contact the subscriber situated in the restriction area. In addition, it is Possible to prevent useless recalling due to its being impossible to contact the subscriber situated in the restriction area and prevent increase of the useless load on the network.

Connection to the disaster message service system can be implemented by dialing a special number designated in advance. Access to the disaster Web site can be implemented by accessing to the server designated in advance.

It is necessary to install a special number or server information in advance in the subscriber terminal 11A. In order to correspond to the change of the special number or the server information, it is preferable to have a system whereby newest information therein can be downloaded.

The present invention is not limited to these embodiments, but variations and modifications may be made without departing from the scope of the present invention.

For example, the mobile communication system is discussed as an example in the above-discussed embodiment. However, the present invention is not limited to this example. The present invention can be applied to a point-to-point communication system.

The disaster option control part 30 corresponds to means for indicating in claims below. The data base 80 corresponds to means for storing in claims below. The core network restriction monitoring part 73 corresponds to means for monitoring in claims below. The message notification control part 82 or 95 corresponds to means for notifying a message in claims below. The e-mail refusal lifting part 64 corresponds to means for lifting an e-mail refusal mode in claims below. The emergency e-mail notifying part 65 corresponds to means for notifying an emergency e-mail in claims below.

This patent application is based on Japanese Priority Patent Application No. 2006-148339 filed on May 29, 2006, the entire contents of which are hereby incorporated by reference.

What is claimed is:

1. A congestion control method, comprising the steps of:
calling from a first subscriber terminal to a second subscriber terminal, the second subscriber terminal positioned within a communication restriction area,
communicating to the first subscriber terminal that connection to the second subscriber terminal cannot be made; and
making the first subscriber terminal select one of a disaster system or an e-mail function.

2. The congestion control method as claimed in claim 1,
wherein, when the disaster system is selected by the first subscriber terminal, the disaster system stores a message from the first subscriber terminal to the second subscriber terminal, and
when communication restriction of the second subscriber terminal is lifted, the disaster system calls the second subscriber terminal so as to communicate the message.

3. The congestion control method as claimed in claim 2,
wherein, when the communication restriction of the second subscriber terminal is lifted, the disaster system repeatedly calls the second subscriber terminal until the second subscriber terminal receives the calling.

4. The congestion control method as claimed in claim 2,
wherein the second subscriber terminal notifies the disaster system that the message is received.

5. The congestion control method as claimed in claim 1,
wherein, when the e-mail function is selected by the first subscriber terminal, an emergency e-mail generated by the first subscriber terminal is sent to the second subscriber terminal and stored by the disaster system.

6. The congestion control method as claimed in claim 1,
wherein, the disaster system is one of a disaster message service and a disaster Web site.

7. A congestion control method, comprising:
when calling is made from a first subscriber terminal to a second subscriber terminal positioned within a communication restriction area,
indicating to the first subscriber terminal that connection to the second subscriber terminal cannot be made;
connecting to a disaster system by the first subscriber terminal so that a message is sent to the second subscriber terminal;
storing the message from the first subscriber terminal to the second subscriber terminal by the disaster system; and
calling the second subscriber terminal by the disaster system when communication restriction of the second subscriber terminal is lifted, so that the message is sent.

8. A congestion control method, comprising:
when calling is made from a first subscriber terminal to a second subscriber terminal positioned within a communication restriction area,
indicating to the first subscriber terminal that connection to the second subscriber terminal cannot be made;
generating an emergency e-mail to the second subscriber terminal by an e-mail function of the first subscriber terminal; and
sending the emergency e-mail to the second subscriber terminal and storing the emergency e-mail by a disaster system.

9. A congestion control method, comprising:
when calling is made from a first subscriber terminal to a second subscriber terminal positioned within a communication restriction area,
indicating a restriction state in the communication restriction area to the first subscriber terminal; and
determining switching to connection to a disaster system or an e-mail function, depending on the restriction state, by the first subscriber terminal.

10. A congestion control method, comprising:
when calling is made from a first subscriber terminal to a second subscriber terminal positioned within a communication restriction area,
indicating a restriction state in the communication restriction area to the first subscriber terminal; and
indicating selectable switching to connection to a disaster system or an e-mail function, depending on the restriction state, to the first subscriber terminal, and making the first subscriber terminal select either switching.

11. A subscriber terminal, comprising:
an indicating part configured to select switching to either connection to a disaster system or an e-mail function, in a case where a core network indicates that connection to another subscriber terminal positioned within a communication restriction area cannot be made while calling to the other subscriber terminal is being attempted.

12. The subscriber terminal as claimed in claim 11,
wherein the connection to the disaster system is either connection to a disaster message service or access to a disaster Web site.

13. A disaster system, comprising:
a storing part configured to store a message from a first subscriber terminal to a second subscriber terminal;
a monitoring part configured to monitor a core network so as to monitor a state of receiving restriction of the second subscriber terminal; and
a message notifying part configured to call the second subscriber terminal in a case where communication restriction of the second subscriber terminal is lifted and send the message stored in the storing part and to the second subscriber terminal.

14. The disaster system as claimed in claim 13,
wherein the message notifying part calls the second subscriber terminal until the second subscriber terminal receives the message in a case where the communication restriction of the second subscriber terminal is lifted.

15. A core network, comprising:
an e-mail refusing mode lifting part configured to lift an e-mail refusing mode, in a case where an emergency e-mail is sent from a first subscriber terminal to a second subscriber terminal positioned within a communication restriction area and the second subscriber terminal is in the e-mail refusing mode; and
an emergency e-mail notifying part configured to send the emergency e-mail to a disaster system.
